(19) United States
(12) Patent Application Publication
(10) Pub. No.: US 2024/0172245 A1
(43) Pub. Date: May 23, 2024

(54) ENHANCEMENTS FOR TCI ACTIVATION AND APPLICATION IN COMMON TCI OPERATION

(71) Applicant: INTERDIGITAL PATENT HOLDINGS, INC., Wilmington, DE (US)

(72) Inventors: Patrick SVEDMAN, Stockholm (SE); Pascal ADJAKPLE, Great Neck, NY (US); Kyle PAN, Saint James, NY (US); Allan TSAI, Boonton, NJ (US); Yifan LI, Conshohocken, PA (US)

(21) Appl. No.: 18/553,930

(22) PCT Filed: Apr. 5, 2022
(86) PCT No.: PCT/US2022/071540

§ 371 Date: Oct. 4, 2023

Related U.S. Application Data
(60) Provisional application No. 63/170,798, filed on Apr. 5, 2021.

(51) Int. Cl. H04W 72/231; H04W 72/1268; H04W 72/21; H04W 76/20

(52) U.S. Cl. CPC H04W 72/231; H04W 72/1268; H04W 72/21; H04W 76/20

(57) ABSTRACT

Methods, apparatus, and systems are described for addressing common beam operation, in which a Transmission Configuration Indicator (TCI) state (e.g., beam) may be indicated by a Downlink Control Information (DCI) and subsequently be applied to both control and data channels and, in some aspects, to both downlink and uplink.

### CROSS-REFERENCE TO RELATED APPLICATIONS

This application claims the benefit of U.S. Provisional Application No. 63/170,798, filed Apr. 5, 2021, entitled “Enhancements for TCI Activation and Application in Common TCI Operation,” the contents of which is hereby incorporated by reference in its entirety.

### BACKGROUND

In unified TCI state framework (also called “common beam”), a pool of TCI states is RRC configured. A subset of the TCI states in the pool can be activated by MAC CE. A UE is expected to track the RSs in the activated TCI states, but not necessarily RSs in TCI states in the pool that are not activated. Due to UE complexity and power consumption, the number of activated TCI states in a cell is limited, e.g., maximum 8 activated TCI states.

The gNB can indicate one of the activated TCI states in a DCI. Once the TCI state has been applied, it remains in use until another TCI state is indicated by a later DCI. An activation command in a MAC CE followed by an indication in a DCI (incl. a potential acknowledgement for the indication) may result in longer latency than needed, and perhaps with some unnecessary DCI overhead. Frequent MAC CE activation may be needed in several important scenarios. An efficient MAC CE activation scheme having shorter latency and lower overhead is desirable and required

Common beam operation in 5G networks may encompass a wide variety of scenarios, servers, gateways, and devices, such as those described in, for example: Samsung, RP-202024—“Revised WID: Further enhancements on MIMO for NR”, September 2020; 3GPP TS 38.214 V16.4.0; 3GPP TS 38.101-2 V16.5.0; 3GPP TS 38.321 V16.3.0; 3GPP TS 38.331 V16.3.1; and 3GPP TS 38.133 V16.6.0.

### SUMMARY

Described herein are methods, apparatus, and systems for common beam operation including enhancements for TCI activation and application in common TCI operation.

According to some aspects, a TCI state (e.g., beam) may be indicated by a DCI and subsequently be applied to both control and data channels, and potentially also to both downlink and uplink. A TCI state indicated by a DCI may be selected from a set of TC states that have been activated by MAC CE. In one aspect, a default TCI state may be used upon MAC CE based activation which may, for example, result in a TCI being applied with lower latency and overhead. Moreover, solutions related to the interaction between a TCI state indicated in a DCI and a default TCI state are also provided.

According to some aspects, alternatives to TCI state application following an indication in a DCI are provided. In one aspect, a solution is provided regarding a scenario with TCI indication by DCI in conjunction with the activation time of the corresponding TCI state.

According to some aspects, an apparatus may include one or more of a next generation Node B (gNB) or a user equipment (UE). The apparatus may include a processor, communications circuitry, and a memory. The memory may store instructions that, when executed by the processor, cause the apparatus to perform one or more operations. According to some aspects, one or more steps may be included in a method.

In one aspect, a first set of TCI states may be activated using a MAC CE. A first TCI state associated with the first set of TCI states may be determined based at least in part on a DCI from the first set of TC states. The first set of TC states may be associated with a CORESET pool index value. The DCI may be received on a CORESET and a TCI used for the CORESET may be applied by a UE. Moreover, the MAC CE may include a TC state identification field for a TCI codepoint and/or a number of TC state identifiers for activation.

In one aspect, the determined first TCI state may be applied to at least one control channel or data channel. The determined first TCI state may be applied to a PUCCH and/or a PUSCH. For example, the PUCCH or PUSCH may be scheduled or activated by a PDCCH received on a CORESET associated with the CORESET pool index value. Moreover, the determined first TCI state may be applied to a PDCCH received on a CORESET associated with the CORESET pool index value or a PDSCH. The PDSCH may be scheduled by a PDCCH received on a CORESET associated with the CORESET pool index value. According to some aspects, a second TC state associated with the first set of TCI states may be determined. After activating the first set of TCI states and before applying the determined first TCI state, the determined second TCI state may be applied to the at least one control channel or data channel.

According to some aspects, a second set of TCI states may be activated by the MAC CE. A second TCI state associated with the second set of TCI states may be determined based at least in part on the DCI. The determined second TCI state may be applied to a PUCCH or a PUSCH. Moreover, the determined first TCI states may be applied to a PDCCH or a PDSCH. The PUCCH or PUSCH may be scheduled or activated by a first PDCCH received on a first CORESET associated with the CORESET pool index value. The determined first TCI state may be applied to a second PDCCH received on a second CORESET associated with the CORESET pool index value or a PDSCH. The PDSCH may be scheduled by a third PDCCH received on a third CORESET associated with the CORESET pool index value.

According to some aspects, the first TCI state may be applied to a subset of CORESETs, where the subset of CORESETs may be associated with a CORESET pool index value. In one aspect, a TCI codepoint may be determined based at least in part on the DCI, where the CORESET pool index value may be associated with the TCI codepoint. In another aspect, the CORESET pool index value may be associated with a TCI activation received in the MAC CE, where the MAC CE may be received in a PDSCH scheduled by a PDCCH received on a CORESET associated with the CORESET pool index value.

This Summary is provided to introduce a selection of concepts in a simplified form that are further described below in the Detailed Description. This Summary may not be intended to identify key features or essential features of the claimed subject matter, nor is it intended to be used to limit the scope of the claimed subject matter. Furthermore, the claimed subject matter may not be limited to features that solve any or all disadvantages noted in any part of this disclosure.

### BRIEF DESCRIPTION OF THE DRAWINGS

A more detailed understanding may be had from the following description, given by way of example in conjunction with accompanying drawings wherein:

FIG. 1 shows an exemplary illustration of MAC CE for joint and/or separate TCI activation.

FIG. 2 shows an exemplary illustration of MAC CE for joint and/or separate TC activation.

FIG. 3 shows an exemplary illustration of MAC CE for joint and/or separate TC activation.

FIG. 4 shows an exemplary illustration of MAC CE for joint and/or separate TCI activation.

FIG. 5 shows an exemplary illustration of TC activation delay of known and unknown TCIs (or TC states).

FIG. 6 shows an exemplary illustration of application of default TCI.

FIG. 7 shows an exemplary illustration of application of default TCI.

FIG. 8 shows an exemplary illustration of application of default TCI.

FIG. 9 shows an exemplary illustration of application of default TCI.

FIG. 10 shows an exemplary illustration of application of default TCI.

FIG. 11 shows an exemplary illustration of basic procedure for application of TCI.

FIG. 12 shows an exemplary illustration of TCI application timeline Alt 1.

FIG. 13 shows an exemplary illustration of TC application timeline Alt 2A.

FIG. 14 shows an exemplary illustration of TC application timeline Alt 2A.

FIG. 15 shows an exemplary illustration of TCI application timeline Alt 2A.

FIG. 16 shows an exemplary illustration of TCI application timeline Alt 2B.

FIG. 17 shows an exemplary illustration of TC application timeline Alt 2B.

FIG. 18 shows an exemplary illustration of TCI application timeline Alt 2B.

FIG. 19 shows an exemplary illustration of TCI application timeline Alt 2B.

FIG. 20 shows an exemplary illustration of TC application timeline Alt 3.

FIG. 21 shows an exemplary illustration of TC application timeline Alt 3.

FIG. 22 shows an exemplary illustration of TCI activation and application.

FIG. 23 shows an exemplary illustration of TCI activation and application.

FIG. 24 shows an exemplary illustration of TCI activation and application.

FIG. 25 shows an exemplary illustration of TCI activation and application timeline.

FIG. 26 shows an exemplary illustration of TCI activation, application and default TCI.

FIG. 27 shows an exemplary illustration of TCI application timeline.

FIG. 28 shows an exemplary illustration of TCI application timeline.

FIG. 29 shows an example of multiple DCIs with the same TCI application time.

FIG. 30 shows an example of multiple DCIs with the same TCI application time.

FIG. 31 shows an example of multiple DCIs with out-of-order TCI application time.

FIG. 32A illustrates an example communications system.

FIGS. 32B, 32C, and 32D are system diagrams of example RANs and core networks.

FIG. 32E illustrates another example communications system.

FIG. 32F is a block diagram of an example apparatus or device, such as a WTRU.

FIG. 32G is a block diagram of an exemplary computing system.

### DETAILED DESCRIPTION

Table 1 describes some of the abbreviations used herein.

TABLE 1
Abbreviations

| | |
|---|---|
| ACK | Acknowledgement |
| BM | Beam Management |
| CC | Component Carrier |
| CORESET | Control Resource Set |
| CSI-RS | Channel State Information RS |
| DCI | Downlink Control Information |
| DL | Downlink |
| DMRS | Demodulation RS |
| DTX | Discontinuous Transmission |
| FDM | Frequency Division Multiplexing |
| FDMed | Frequency Division Multiplexed |
| FR | Frequency Range |
| FR1 | FR spanning lower frequencies, e.g., 410 MHz-7125 MHz. |
| FR2 | FR spanning higher frequencies, e.g., 24250 MHz- |
| | 52600 MHz. |
| gNB | NR NodeB |
| ID | identity and/or index |
| IE | Information Element |
| FeMIMO | Further enhanced MIMO (a 3GPP Rel-17 work item) |
| L1 | Layer 1 |
| MAC | Medium Access Control |
| MAC CE | MAC Control Element |
| MIMO | Multiple Input Multiple Output |
| ms | milliseconds |
| NACK | Negative ACK |
| NR | New Radio |
| NW | Network |
| NZP | Non-Zero Power |
| PCell | Primary Cell |
| PDCCH | Physical Downlink Control Channel(s) |
| PDSCH | Physical Downlink Shared Channel(s) |
| PHY | Physical Layer |
| PUCCH | Physical Uplink Control Channel(s) |
| PUSCH | Physical Uplink Shared Channel(s) |
| QCL | Quasi Co-Location |
| RAN | Radio Access Network |
| Rel | Release |
| RRC | Radio Resource Control |
| RS | Reference Signal(s) |
| RSRP | RS Received Power |
| RX (or Rx) | Reception or Receive or Receiver |
| SCell | Secondary Cell |
| SFN | Single Frequency Network |
| SNR | Signal to Noise Power Ratio |
| SINR | Signal to Interference and Noise Power Ratio |
| SpCell | Special Cell (PCell or PSCell) |
| SRS | Sounding RS |
| SS | Synchronization Signal |
| SSB | SS/PBCH Block |
| SSS | Search Space Set |
| TB | Transport Block |
| TCI | Transmission Configuration Indicator |
| TRP | Transmission and/or Reception Point |
| TRS | Tracking Reference Signal(s) (or CSI-RS (resource set) |
| | for tracking) |
| TX (or Tx) | Transmission or Transmit or Transmitter |
| UE | User Equipment |
| UL | Uplink |

### Quasi Co-Location (QCL) in NR

According to some embodiments, the network can configure/indicate to the UE QCL-relationships between different RSs. A QCL-relationship has a source RS and a target RS (the target can also be a physical channel, but this example is henceforth omitted for brevity). The QCL-relationship can assist the UE in the reception and/or processing of the target RS by applying one or more parameters estimated from the source RS.

The network can configure for which kind of parameters a QCL-relationship holds. For example, the following QCL types may be defined: ‘QCL-TypeA’: {Doppler shift, Doppler spread, average delay, delay spread} ‘QCL-TypeB’: {Doppler shift, Doppler spread} ‘QCL-TypeC’: {Doppler shift, average delay}; and ‘QCL-TypeD’: {Spatial Rx parameter}.

The source RS can be synchronization signal/PBCH block (SSB) or CSI-RS resource (also called CSI-RS herein for brevity).

The target RS can be CSI-RS resource, DMRS of PDCCH, or DMRS of PDSCH.

### Known and Unknown TCI States

A UE may be configured to measure some signals and then report the measurement result. A UE may be configured with other signals for which the UE is not configured to report measurement results. It may often be assumed that the UE has performed some operations on the former signals (e.g., UE RX beam adjustment), but not on the latter signals. According to some embodiments, this is related to the concept of known and unknown TC states.

The TCI state is known if the following conditions are met during the period from the last transmission of the RS resource used for the L1-RSRP measurement reporting for the target TCI state to the completion of active TCI state switch, where the RS resource for L1-RSRP measurement is the RS in target TC state or QCLed to the target TCI state:
(1) TCI state switch command is received within 1280 ms upon the last transmission of the RS resource for beam reporting or measurement;
(2) the UE has sent at least 1 L1-RSRP report for the target TCI state before the TCI state switch command;
(3) the TCI state remains detectable during the TC state switching period;
(4) the SSB associated with the TCI state remain detectable during the TCI switching period; and
(5) SNR of the TCI state ≥−3 dB;

Otherwise, the TCI state is unknown.

The TCI state activation delay is typically significantly longer if the TCI state is unknown than if the TCI state is known.

### Problem Statement

Problem 1—TCI State Application Latency

In unified TCI state framework (also called “common beam”), a pool of TCI states is RRC configured. A subset of the TCI states in the pool can be activated by MAC CE. A UE is expected to track the RSs in the activated TCI states, but not necessarily RSs in TCI states in the pool that are not activated. Due to UE complexity and power consumption, the number of activated TCI states in a cell is limited, e.g., maximum 8 activated TCI states.

The gNB can indicate one of the activated TCI states in a DCI. Once the TCI state has been applied, it remains in use until another TCI state is indicated by a later DCI. An activation command in a MAC CE followed by an indication in a DCI (e.g., including a potential acknowledgement for the indication) may result in longer latency than needed, and perhaps with some unnecessary DCI overhead. It is foreseen that frequent MAC CE activation may be needed in several important scenarios. An efficient MAC CE activation scheme having shorter latency and lower overhead is desirable and required.

Problem 2—Default TCI State

One potential solution to problem 1 for achieving shorter latency and lower overhead MAC CE activation involves the definition of a default TCI state, which may be applied upon TCI state activation, e.g., prior to the TCI application time following a DCI. However, how a default TCI state is indicated or selected needs to be defined.

One or more default TCI states may be defined and applied, following a MAC CE activation command. However, a TCI may also be indicated by a TCI codepoint in a DCI. The interaction and priority between default TCI and indicated TCI needs to be resolved.

Problem 3—TCI Application Timeline Upon TCI Activation

There are several options regarding when a TCI state indicated in a DCI can be applied, e.g., a certain time after the reception of the DCI or a certain time after the transmission of the corresponding acknowledgement.

For DCIs received around the time of TCI state activation, there are a number of cases with ambiguous behavior, which need to be resolved.

### Transmission Configuration Indicator (TCI)

TCI is a concept that may be used by the network to indicate a certain relationship between different signals and/or channels, e.g., quasi co-location (QCL), as described in Quasi Co-Location (QCL) in NR. Some properties, e.g., parameters, may be derived from a source RS in a TCI and used while receiving and/or decoding a target RS or channel. One example of such a property is a spatial Rx parameter (QCL-TypeD). Such a QCL relation may imply that the UE may derive a suitable receive beam for the target RS/channel from the source RS. Other examples include parameters related to Doppler and delay. According to some embodiments, beam may be used as a shorthand for TCI, since a TCI may correspond to a beam. A beam may correspond to a DL TX beam and/or a DL RX beam, since different DL TX beams may require different DL RX beams. A beam may also correspond to UL TX beam, since different DL TX beams may correspond to different UL TX beams, e.g., in the case DL RSs are used as spatial references for UL TX beams. However, examples herein that use the beam terminology are also applicable to cases in which TCIs do not contain QCL for a spatial parameter, such as for carrier frequencies in FR1. For instance, examples using the terminology “common beam operation” may be applicable also to cases in which spatial parameters are not applicable, e.g., TCIs do not include source RS with QCL-TypeD. For example in lower frequency bands such as FR1, a UE may be configured with TC states with, for instance, only QCL-TypeA or QCL-TypeC, since a UE might not need to perform DL RX beam training prior to DL signal/channel reception, or UL TX beam training prior to UL signal/channel transmission.

Furthermore, QCL information may be enhanced such that a source RS with QCL-TypeD not only is relevant for a spatial Rx parameter (used for UE's reception of DL), but also for a spatial Tx parameter, such as a spatial domain transmission filter, which may be used for UE's transmission of UL.

The term TCI state may be used herein as a configuration element or information element (e.g., TCI-State or TCI-State-r17), e.g., including one or more RS, corresponding QCL type(s), etc. As further discussed below, one or more TCI may be determined or derived from a TCI state. For example, a DL TCI and an UL TCI may be determined from a TCI state.

The term TCI codepoint may be used herein as an allowed value of a TCI field in a DCI. A TCI codepoint may map to one or more TCI states, e.g., multiple DL TCI states or one TCI state used for DL TCI and one TCI state used for UL TCI. A TCI codepoint may map to one or more TCIs, e.g., one DL TCI and one UL TCI. Note that a TCI state may correspond to one or more TCIs.

### Common Beam Operation

Joint and Separate DL and UL TCI

NR in Rel-15/16 supports a flexible framework for configuring/indicating QCL information for various signals and channels. Different QCL information can be applied to different CSI-RS, different CORESETs (used for monitoring and receiving PDCCH) and PDSCH. Furthermore, different QCL information can be applied to different BWPs in a cell and to different cells. This can imply a large signaling overhead, even if all those signals and channels use the same beam pair (e.g., the beam at the transmitter and the beam at the receiver), which is a quite common scenario. As a consequence, common beam operation will be specified in NR Rel-17, e.g., for overhead and latency reduction. Common beam operation is directly related to and sometimes synonymous with a unified TCI framework.

In common beam operation, source reference signal(s) in M (e.g., M=1 or M≥1) DL TCI(s) provide common QCL information at least for UE-dedicated reception on PDSCH and one or more subset(s) of CORESETs (e.g., all configured CORESET(s)) in a CC (e.g., a serving cell). The common QCL information may also be applied to CSI-RS resources for CSI (e.g., for CSI measurement and reporting), CSI-RS for tracking, and/or CSI-RS for beam management (e.g., aperiodic CSI-RS and/or configured with repetition). For the example of M=2, the UE simultaneously maintains two DL TCI, where the two DL TCIs may be used for transmissions from two TRPs, respectively. Which TCI to use (for PDCCH monitoring, subsequent PDSCH, PUSCH, PUCCH, etc.) may depend on which CORESET pool the transmission is associated with.

Furthermore, source reference signal(s) in N (e.g., N=1 or N≥1) UL TCI(s) provide common QCL information (or reference) for determining UL TX spatial filter, at least for dynamic-grant/configured-grant based PUSCH and all of the dedicated PUCCH resources in a CC (e.g., a serving cell). The common QCL information may also be applied to SRS resources in resource set(s) configured for antenna switching/codebook-based/non-codebook-based UL transmissions. In some cases, it may be applied to SRS for beam management.

The M and/or N TCI(s) may be applied to one or more serving cells, e.g., all cells in a band or all cells in a configured list of serving cells. The TCI(s) may be applied to one, a subset, or all DL and/or UL BWPs of those serving cell(s).

A joint TC may refer to a common source RS used for determining both a DL QCL information (e.g., QCL-TypeD) and the UL TX spatial filter. In this case, M may be equal to N.

Separate TCI may refer to the case that the DL TCI and the UL TCI are distinct, e.g., separate. In this case, M may be equal to N or different from N.

In some cases, the network configures a UE with a pool of TCI states, and TCI states in the pool may be configured as joint TCI or separate TCI. A TCI state configured as separate may include optional additional source RS, for example a second source RS as spatial reference or QCL-TypeD. In such a case, a first source RS, e.g., with QCL-TypeD, could be used in a separate DL TCI and a second source RS, e.g., configured with QCL-TypeD, “spatial reference” or another designation to determine that it is to be used as spatial reference for UL, could be used in a separate UL TCI.

Joint Pool of TC States

In some cases, a pool of TC states can be RRC configured to the UE, where a TCI state could be used to derive joint TCI, (separate) DL TCI and/or (separate) UL TCI.

For example, a TCI state could comprise a set of source RSs with corresponding (per-RS) QCL type information.

In case of joint TCI, both DL TCI and UL TCI could be derived from same TC state. For example, a source RS with QCL-TypeD in a TCI state is used for spatial QCL in the DL TCI as well as the spatial relation (or QCL) in the UL TCI. In other words, the UE may use the same source RS to determine an DL RX beam as well as to determine an UL TX beam.

In case of separate TCI, DL TCI could be derived from a TC state in the pool and UL TCI could be derived from another TCI state in the same pool.

1.1.1 Separate Pools of TCI States

In some cases, multiple pools of TC states can be RRC configured to the UE, where the pools may be disjoint or overlapping. For example, a first pool of TC states could be used to derive joint TCI or (separate) DL TCI, while a second pool of TCI states could be used to derive (separate) UL TCI. In one example, the content of TCI states in the second pool may be similar to the content of the TCI states in the first pool, e.g., include the same set of mandatory and optional parameters. In another example, the content of TCI states in the second pool may be different from the content of the TCI states in the first pool, e.g., include a smaller set of UL-related mandatory and optional parameters.

For example, a TCI state could comprise a set of source RSs with corresponding (per-RS) QCL type information.

In case of joint TCI, both DL TCI and UL TCI could be derived from same TC state from the first pool of TC states. For example, a source RS with QCL-TypeD in a TCI state is used for spatial QCL in the DL TCI as well as the spatial relation (or QCL) in the UL TCI. In other words, the UE may use the same source RS to determine an DL RX beam as well as to determine an UL TX beam.

In case of separate TCI, an DL TCI could be derived from a TCI state in the first pool and an UL TCI could be derived from a TC state in the second pool.

### TCI Activation

Overview

A set of TCIs can be activated, using one or more MAC CEs. Purposes of activation include:

(1) a UE tracks source RS in activated TCIs so that they can be readily used as QCL/spatial reference for other signals/channels with low delay, e.g., the UE might not be required to track source RS in TCIs that are not activated; and

(2) activated TCIs may be mapped to TCI codepoints, e.g., a DCI may indicate one or more TCI codepoint(s) in order to update TCI(s) for common beam operation (see TCI Indication).

In some cases, a MAC CE activates either joint TC or separate DL/UL, e.g., all the TCIs activated in the MAC CE are either joint TCI or separate DL/UL TCI.

In some cases, a MAC CE activates some TCIs that are joint and other that are separate DL/UL TCIs.

The M and/or N TCIs for common beam operation may be indicated, activated/deactivated, or updated dynamically using one or more DCI(s) and/or one or more MAC CE(s). The term indication is often used for DCI-based signaling. For the MAC CE based signaling, the terms activation and deactivation are often used. Updating can be done after an initial indication or activation. Henceforth, the term activation may also include the notion of deactivation, e.g., “activation or deactivation”, since a MAC CE that activates a first set of TCIs may implicitly deactivate a second set of TCIs that were previously activated but are not included in the first set of TCIs. In some cases, a subset of the M and/or N TCIs may be indicated/activated/updated using a DCI and/or a MAC CE. For example, a TCI indication/activation/update in a DCI and/or a MAC CE may apply to a subset of CORESETs associated with a certain CORESET pool index value (e.g., 0 or 1), e.g., through parameter coresetPoolIndex-r16.

In one example, a TCI codepoint received in a first DCI on a CORESET associated with a first CORESET pool index value may be used to indicate/activate/update the TCI state(s) of CORESET(s) with the first CORESET pool index value. A TCI codepoint received in a second DCI on a CORESET associated with a second CORESET pool index value may be used to indicate/activate/update the TCI(s) of CORESET(s) with the second CORESET pool index value. For instance, if the TCI codepoint received in the first DCI indicates a first TCI and the TCI codepoint received in the second DCI indicates a second TCI, then M and/or N may be equal to 2.

In another example, a TCI codepoint received in a DCI may correspond to multiple, e.g., 2, TCIs. In some cases, different subsets of these multiple TCIs are applied to different subsets of CORESET, e.g., a first TC is applied to CORESET(s) associated with a first CORESET pool index and a second TCI is applied to CORESET(s) associated with a second CORESET pool index.

In another example, a TC activation/update received in a first MAC CE in a PDSCH scheduled by a PDCCH received on a CORESET associated with a first CORESET pool index value may be used to indicate/activate/update the TCI(s) of CORESET(s) with the first CORESET pool index value. A TCI activation/update received in a second MAC CE in a PDSCH scheduled by a PDCCH received on a CORESET associated with a second CORESET pool index value may be used to indicate/activate/update the TCI(s) of CORESET(s) with the second CORESET pool index value. In yet another example, a MAC CE for TC activation/update may include a CORESET pool index value that indicates that TCI(s) of CORESET(s) with the CORESET pool index value are to be indicated/activated/updated.

In another example, a TC activation/update received in a MAC CE may correspond to multiple, e.g., 2, TCIs. In some cases, different subsets of these multiple TCIs are applied to different subsets of CORESET, e.g., a first TC is applied to CORESET(s) associated with a first CORESET pool index and a second TCI is applied to CORESET(s) associated with a second CORESET pool index.

In some cases, multiple TCIs, e.g., two TCIs, indicated/activated/updated by a DCI and/or MAC CE are applied to the same CORESET, e.g., a CORESET may have multiple simultaneously active TCIs.

The TCI(s) for PDSCH may follow the TCI(s) of the CORESET(s) in the DL BWP. For example, if M=1 the same TCI is applied to CORESET(s) and PDSCH. For example, if M>1 (e.g., M=2) a UE may apply all or a subset of the M TCIs for PDSCH reception. For example, if M=2, the UE may apply both or one of the TCIs for PDSCH reception. For instance, a UE may apply the TCI(s) used for the CORESET(s) on which the DCI was received that scheduled the PDSCH. In another example with M=2, two TCIs may be associated with a CORESET, which means that PDCCH may be received using two TCIs, for instance on the same time-frequency resource, in the so called SFN-like transmission scheme, or by PDCCH repetition in the time and/or frequency domain, with different PDCCH occasions corresponding to different TCIs. Similarly, multiple TCIs may be used for PDSCH reception, e.g., by SFN-like transmission or by repetition in the time and/or frequency domain, with different PDSCH occasions corresponding to different TCIs.

For example, if M=1 the same TCI is applied to CORESET(s) and PUSCH. For example, if M>1 (e.g., M=2) a UE may apply all or a subset of the M TCIs for PUSCH transmission. For example, if M=2, the UE may apply both or one of the TCIs for PUSCH transmission. For instance, a UE may apply the TCI(s) used for the CORESET(s) on which the DCI was received that scheduled the PUSCH. In another example with M=2, two TCIs may be associated with a CORESET, which means that PDCCH may be received using two TCIs, for instance on the same time-frequency resource, in the so called SFN-like transmission scheme, or by PDCCH repetition in the time and/or frequency domain, with different PDCCH occasions corresponding to different TCIs. Similarly, multiple TCIs may be used for PUSCH transmission, e.g., through multiple UL TRPs or by repetition in the time and/or frequency domain, with different PUSCH occasions corresponding to different TCIs.

In the case of separate DL and UL TCI, different UL TCIs may be associated with different subsets of CORESETs, e.g., CORESETs with different CORESET pool indices. In one example, transmission on a PUCCH resource triggered by PDCCH reception on a CORESET, e.g., for transmission of ACK/NACK for a PDSCH scheduled by a PDCCH on the CORESET, may follow the UL TCI(s) associated with the CORESET. Similarly, transmissions of PUSCH may use UL TCI(s) associated with the CORESET used for scheduling the PUSCH or activating the corresponding configured UL grant.

As for CORESETs and PUSCH, transmission of a PUCCH resource may use multiple UL TCIs (N>1), e.g., multiple UL TCIs associated with a CORESET in which a PDCCH was received that triggered the PUCCH transmission. PUCCH transmission using multiple UL TCIs may comprise repetition in time with different repetitions using different TCIs. Similarly, PUSCH repetition using multiple UL TCIs with different TCIs being used for different PUSCH transmissions is one example of N>1.

TC Activation for Joint TCI

For a joint TCI, the same TC state may be used to determine a DL TCI and an UL TCI. For example, the UE may use the same beam for DL and for UL if the QCL-TypeD source RS for DL is also used as spatial relation/QCL for UL.

Hence, for joint TCI, the MAC CE activation of a TCI state would activate both the DL TCI and the UL TCI, where the TCI state would be taken from the joint pool of TCI states or from the pool of TC states used for joint TCI and DL TC in the case of separate DL/UL TCI. The DL TCI and UL TC may be mapped to the same TCI codepoint.

TCI Activation for Separate DL/UL TCI

In some cases, a MAC CE activates a DL TCI such that it is mapped to a TC codepoint. In some cases, a MAC CE activates an UL TC such that it is mapped to a TCI codepoint. In some cases, the activated TCIs, e.g., corresponding to different TC codepoints, were activated by two different MAC CEs, which may have been multiplexed in the same or different PDSCH(s). For example a first MAC CE activated a set of DL TCIs for a first set of TC codepoints, and a second MAC CE activated a set of UL TCIs for a second set of TCI codepoints. In some cases, a MAC CE activates a separate DL TCI and a separate UL TC such that they are mapped to the same TC codepoint.

In some cases, activation of a joint TCI for a TCI codepoint may be achieved by separately activating a DL TCI and an UL TCI for the same TC codepoint, with the DL TCI and UL TCI including the same source RS(s), for example by pointing to the same TCI state. Separate DL/UL TCI for a TCI codepoint may be achieved by activating a DL TCI and an UL TCI with different source RS(s), for example by pointing to different TCI states, in the same or different pools of TCI states. In this way, the same activation mechanism, e.g., same MAC CE, could be used for both joint and separate DL/UL TCI. For example, a MAC CE for activation may include separate fields for indicating a DL TCI and UL TC for a TCI codepoint.

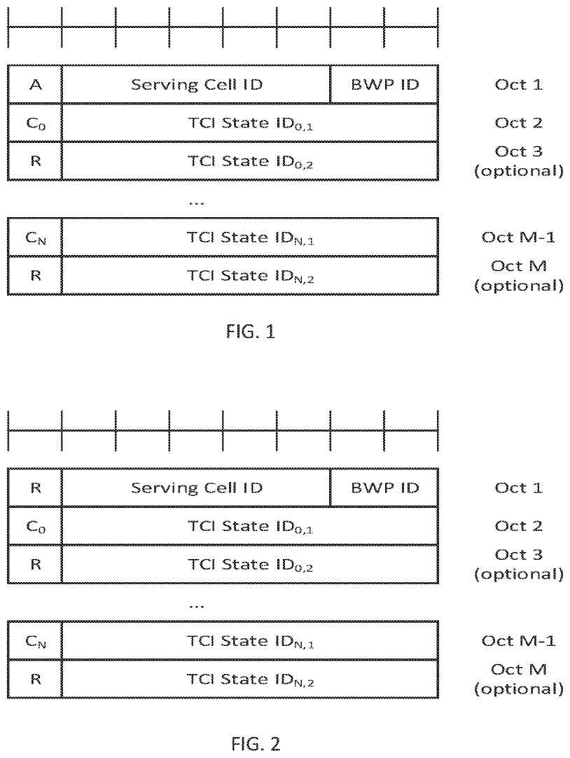

In another example, a MAC CE for TCI activation can include one or two TCI state Id fields for a TC codepoint. The case of one TCI state Id field may correspond to the case of joint TCI. The case of two TC state Id fields may correspond to the case of separate DL/UL TCI, where for example the first field corresponds to the DL TC while the second field corresponds to the UL TCI. Exemplary illustrations are shown in FIG. 1 and FIG. 2, which follow the MAC CE presentation format etc. from 3GPP TS 38.321 V16.3.0. The examples actually follows the “Enhanced TCI States Activation/Deactivation for UE-specific PDSCH MAC CE” in section 6.1.3.24 of 3GPP TS 38.321 V16.3.0, so the MAC CE and its logical channel ID may be reused. In other cases, a new MAC CE is introduced possibly with a new logical channel ID for the new MAC CE.

According to some embodiments, the field definitions may follow section 6.1.3.24 of 3GPP TS 38.321 V16.3.0 with the following potential updates.

A: Can be set to 0 or 1. In some cases, it can indicate if the MAC CE is for “Enhanced TCI States Activation/Deactivation for UE-specific PDSCH MAC CE” (e.g., as in Rel-16) or for TC State Activation/Deactivation for Unified TC framework, e.g., as described herein. For example, if set to 0, it indicates the MAC CE is for “Enhanced TC States Activation/Deactivation for UE-specific PDSCH MAC CE” as in Rel-16, and if set to 1, it indicates TCI State Activation/Deactivation for Unified TCI framework, e.g., as described herein. In this embodiment, the logical channel ID for the “Enhanced TCI States Activation/Deactivation for UE-specific PDSCH MAC CE” (e.g., as in Rel-16) may be re-used. In an alternative embodiment, illustrated in FIG. 2, the Rel-16 “Enhanced TCI States Activation/Deactivation for UE-specific PDSCH” MAC CE SDU is re-used as is with no change, e.g., includes all the reserved bits, with no repurposing of the R bit in the first octet of the MAC CE SDU into an field as proposed in FIG. 1. Instead, a new logical channel ID as introduced herein, is used to differentiate between the “Enhanced TCI States Activation/Deactivation for UE-specific PDSCH MAC CE” (e.g., as in Rel-16) and the MAC CE for the indication of TC State Activation/Deactivation for Unified TC framework as described herein.

TCI state ID_{i,j}: This field indicates the TCI state identified by TCI-StateId as specified in 3GPP TS 38.331 V16.3.1, where i is the TCI codepoint index and TCI state ID_{i,j} denotes the jth TC state indicated for the ith TC codepoint index. The TCI codepoint to which the TCI States are mapped is determined by its ordinal position among all the TCI codepoints with sets of TCI state ID_{i,j} fields, e.g., the first TC codepoint with TCI state ID0,1 and TC state ID0,2 shall be mapped to the codepoint value 0, the second TCI codepoint with TCI state ID1,1 and TCI state ID1,2 shall be mapped to the codepoint value 1 and so on. The TC state IDi,2 is optional based on the indication of the Ci field. The maximum number of activated TCI codepoint is K (e.g., 8), e.g., N<K and the maximum number of TC states mapped to a TC codepoint is L (e.g., 2).

In some cases, for example if a UE is configured with common beam operation, if the new MAC CE logical channel ID introduced herein in support of TC State Activation/Deactivation for Unified TCI framework is used, or if the MAC CE logical ID specified for “Enhanced TC States Activation/Deactivation for UE-specific PDSCH MAC CE” (e.g., as in Rel-16) is used, and the field A is set to 1, the field TCI state ID_{i,j} may be interpreted as follows:
If a single TC state is activated for a TC codepoint i, e.g., Ci=0:
For example, TCI state IDi,1 indicates a joint TCI.
For example, TCI state IDi,1 indicates a DL TCI.
For example, TCI state IDi,1 indicates a UL TCI, e.g., if the TC state ID points to a TCI state in a separate pool for UL TCI.
If two TC states are activated for a TCI codepoint i, e.g., Ci=1:
For example, TCI state IDi,1 indicates a DL TCI.
For example, TCI state IDi,2 indicates an UL TCI.
In one example, TCI state IDi,2 equals TCI state IDi,1, which may mean that a joint TCI is indicated for activation.
In one example with separate pools of TC states for DL and UL TCI,
if TCI state IDi,2 points to a TCI state in the first pool that includes DL TCI states, as discussed above, it indicates activation of a second DL TCI, e.g., for PDCCH and/or PDSCH transmission with multiple DL TCIs such as for multi-TRP based DL transmission.
if TCI state IDi,2 points to a TCI state in the second pool that includes UL TC states, as discussed above, it indicates activation of an UL TCI.

In some cases, for example if a UE is not configured with common beam operation, if the new MAC CE logical channel ID introduced herein in support of TCI State Activation/Deactivation for Unified TCI framework is not used, or if the MAC CE logical ID specified for “Enhanced TCI States Activation/Deactivation for UE-specific PDSCH MAC CE” (e.g., as in Rel-16) is used, and the filed A is set to 0, the field TCI state ID_{i,j} may be interpreted as in a legacy system, e.g., as in section 6.1.3.24 of 3GPP TS 38.321 V16.3.0.

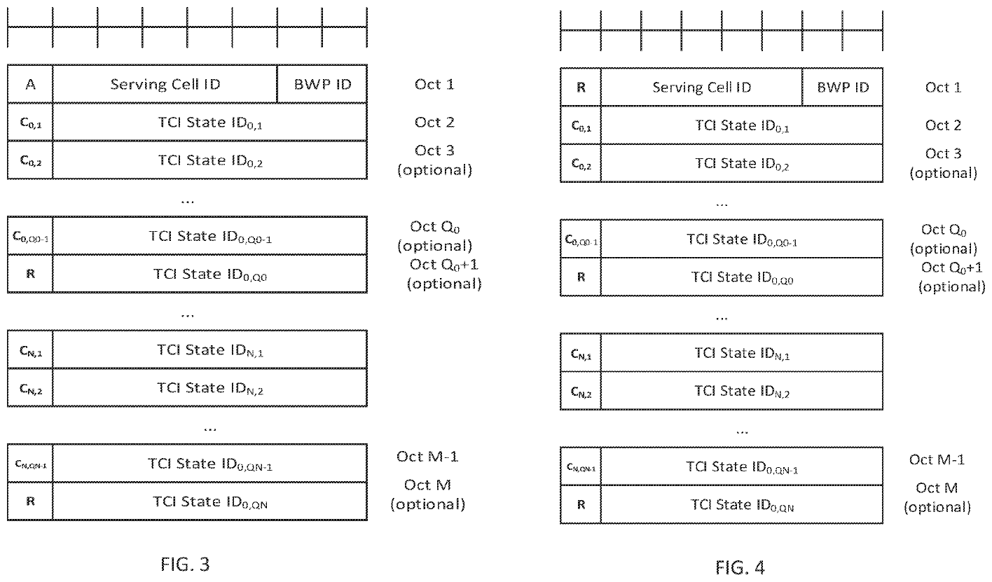

The example above can be readily extended to more than two indicated TCI state IDs per TC codepoint i. The number of indicated TCI state IDs for activation per TCI codepoint i in a MAC CE may be denoted Qi. In an exemplary extension of the MAC CE illustrated in FIG. 1, the field Ci may be replaced with a field Ci,q, with q=1, . . . , Qi, which indicates whether the next octet for TCI codepoint i is present. For example Ci,q=0 for q=Qi, and Ci,q=1 for q<Qi, with the possible exception that there is no Ci,q field for the last octet in the case of a maximum number of octets per TCI codepoint i, in which case an R field may be used instead. In other words, the fields TCI state IDi,1, . . . , TCI state IDi,Qi are included for codepoint i. These examples are illustrated in FIG. 3 (with A field in first octet) and in FIG. 4 (with R field in first octet).

Some examples of interpretation of these TCI state IDs are discussed below:
Qi=3:
   The first two TCI state IDs correspond to activation of two DL TCIs and the third TCI state ID corresponds to activation of an UL TCI.
   The first TC state ID correspond to activation of a DL TCI and the second and third TCI state IDs corresponds to activation of UL TCIs.
Qi=4:
   The first two TCI state IDs correspond to activation of two DL TCIs and the third and fourth TCI state IDs corresponds to activation of UL TCIs.

In another example, for a TCI code point i, a MAC CE may indicate one or more of the following:
a number of indicated TCI state IDs for activation (e.g., similar to Qi TC state IDs in the example above),

For the indicated TCI state IDs:
it may be indicated if the corresponding TCI state is for joint TCI or for separate DL/UL TCI.
For separate DL/UL TCI, e.g., in the case of joint pool of TCI states (see Joint Pool of TCI States), it may be indicated if the TCI state is for determining DL TCI or UL TCI.
For separate DL/UL TCI, e.g., in the case of separate pool of TC states (see Separate Pools of TCI States), a UE may determine that a TC state is for DL TCI if the TCI state ID is from the first pool of TC states (for joint or DL TCI), or that a TC state is for UL TCI if the TCI state ID is from the second pool of TCI states (for UL TCI).

In some cases, a MAC CE activates only joint TC or separate DU/UL TCI. In one example, a bit in the MAC CE may indicate which of the two cases that applies.

If a UE is configured to operate with separate DL/UL TCI, and/or separate DL/UL TC operation is activated using a MAC CE, a DL TCI and an UL TCI corresponding to a TC codepoint may include the same source RS. Such a situation may in effect be considered as a joint TC for the codepoint.

In various cases, a MAC CE activates a TC state for a TCI codepoint, and a DCI that indicates the TCI codepoint also indicates whether the TCI state is to be used for joint TCI, DL TCI or UL TCI.

TCI Activation Timeline

Upon reception of an activation command in a MAC CE, it may take some time before a TCI activated by the MAC CE can be used. The UE may need to receive a source RS or an RS QCL with the source RS before being able to use the TC as QCL reference for receiving other signals/channels. To avoid ambiguity in which TCI that shall be used or assumed for various signals/channels, it is beneficial if the gNB and UE have the same understanding of the TCI activation timeline, e.g., when a TCI included in a TC activation MAC CE actually is activated. This common understanding is assumed herein.

The TCI activation timeline may be relative to:
(1) the time the UE received the PDSCH carrying the activation MAC CE, e.g., the slot in which the PDSCH was received;
(2) the time the UE would transmit the PUCCH with HARQ-ACK information corresponding to the PDSCH carrying the activation MAC CE, e.g., the slot in which it would be transmitted; or
(3) the time the UE has successfully decoded the PDSCH carrying the activation MAC CE.

In case of PDSCH repetition, the timeline may be relative to the last transmission. In case of PUCCH repetition, the timeline may be relative to the first transmission in some cases and relative to the last transmission in other cases. The PUCCH-based reference point may be used even if the HARQ-ACK is in fact multiplexed in a PUSCH, by using the time the UE would have transmitted the PUCCH.

A TCI (or TCI state) may be considered to be “known” or “unknown”, as described in Known and Unknown TCI States. TCI activation is typically significantly longer if the TCI is unknown than if it is known.

A known TC may be already activated or not, which may also have an impact on activation delay. For example, a TC may be already activated for DL TCI when a MAC CE is received that activates an UL RS that includes the same source RS (or the same RS is QCLed with the source RS) as the already activated DL TCI. The activation delay of an already activated known TCI may be shorter than a not already activated known TCI.

Furthermore, the activation delay of a known TC state may also depend on other factors such as the time to the first SSB transmission after the MAC CE decoding, which may be different for different SSBs.

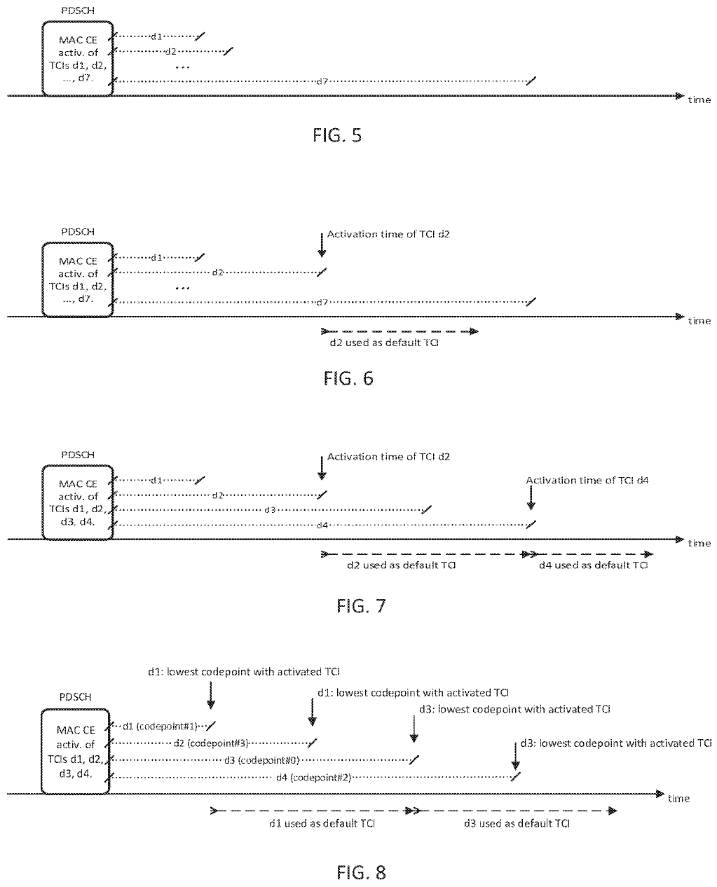

A TC activation command in a MAC CE may include only known TCIs, only unknown TCIs, or a mix of known and unknown TCIs, as well as a mix of already activated known TCIs and not already activated TCIs. FIG. 5 illustrates TCI activation delay after the reception of a PDSCH carrying a MAC CE for activation of a set of TCIs (or TCI states) d1, d2, . . . d7.

Given the discussion above, the (nominal) activation delays for the different TCIs in the set may be quite different. To handle this, two options may be considered:
(1) (Actual assumed) activation delay of all TCIs follows the longest (nominal) TCI activation delay, e.g., of an unknown TC state; and
(2) (Actual assumed) activation delays of different TCIs in the set follow their individual (nominal) TCI activation delay.

The first option may be easier to handle, but it may also result in unnecessarily long delay for all TCIs if at least one activated TC requires long activation delay, e.g., it is unknown. In some aspects, we may assume that the second option is used.

An enhancement attempting to balance the two options may be based on dividing the TCIs activated by a MAC CE into different groups based on the corresponding TCI activation delay. For example, unknown TCIs are included in one group, known TCIs are included in another group. In some cases, the known TCI could be divided into further groups, e.g., already activated known TCIs, not already activated known TCIs, etc. The (actual assumed) activation delay of the TCIs in a group could follow the longest (nominal) TCI activation delay among the TCIs in the group. An advantage of such an enhancement could be that it is simpler for the UE and network to keep track of the time instances of activation, since there would be fewer time instances compared to following the individual TCI activation delays. Still, only a small amount of TC activation delay would be sacrificed due to similar delays within each group (but perhaps large differences between groups).

Default TCI in Unified TCI Framework

In general, to be used as a QCL source for signals/channels in the unified TCI framework, a TC first needs to be RRC configured, activated by MAC CE and finally indicated by a DCI TCI codepoint. However, there may be a few cases in which a TC may be used even though it wasn't indicated by a DCI. For example: (1) a single TCI is activated by a MAC CE: or (2) a default TCI is applied upon activation.

In the first case, a single TCI is activated, which is mapped to a single TCI codepoint. Hence, there is no need to indicate a TCI codepoint with a DCI. This case includes both activation of a joint TC as well as activation of a separate DL TCI and an UL TCI.

In the second case, multiple TCIs are activated by a MAC CE, that are mapped to multiple TCI codepoints. Normally, one of the codepoints would have to be indicated by a DCI before it would be applied to the signals/channels included in the common beam operation. However, with default TCI, one of the TCIs or TC codepoints is applied upon TCI activations, without it being indicated by a TCI.

In some cases, a UE can report its capability to support default TCI or a capability related to default TCI to the gNB or network. In some cases, the gNB or network can configure a UE to use default TCI or a capability related to default TCI.

In some cases, a default TC is based on the lowest or highest activated TCI codepoint, e.g., TCI(s) corresponding to TCI codepoint 0.

In some cases, a MAC CE activation command includes an indication, e.g., a bit, whether a default TCI should be applied for the activation command, e.g., upon activation. In some cases, a MAC CE activation command includes an indication of which TCI(s) that is default TCI(s), e.g., to be applied upon activation. For example, a bit per TC codepoint for which TCI(s) was activated may indicate whether the corresponding TCI(s) is default TCI, with the constraint that at most one of the bits is set. In some cases, multiple bits may be set. e.g., multiple TCIs may be selected as default TCI.

In some cases, a default TC is the current/previous (already applied) TCI(s) at the time of activation, if the current/previous (already applied) TCI(s) is still among the MAC CE activated TCI(s). In other words, the currently used TCI(s) is not changed (to another default TCI) upon activation, unless the MAC CE deactivated the currently used TCI(s). If so, another TCI(s) may be selected as default, e.g., following another case herein.

In some cases, a default TCI or default TCI priority may be RRC configured, e.g., together with the TCI state configuration.

As illustrated in FIG. 5, different TCI(s) activated by a MAC CE command may be (at least nominally) activated at different points in time, e.g., based a plurality of factors such as if the TCI is known, if it is already activated, and the time until first transmission of a related SSB. Furthermore, given the fact that a TCI may serve as a default TCI only after its activation time, this may give rise to an uncertainty of which TCI that serves as default TCI in which point in time.

In some cases, a TCI is applied as a default TCI upon its own activation time, regardless of the activation times of other TC states activated by the same MAC CE activation command. This is illustrated in FIG. 6. The MAC activation command activates a set of TCIs (d1, . . . , d7), of which d2 is to be used as default TCI. Even though other TCIs may be activated (e.g., have activation time) before d2, a default TCI is not applied until the activation time of d2.

This situation may result in ambiguities since a TCI (activated by the same MAC CE) with earlier activation time (e.g., d1) may be indicated by a TCI codepoint in a DCI before the activation time of the default TCI. The corresponding application time (e.g., of d1) may be before or after the default TC activation time. In some cases, the default TC is not applied if another TCI, activated by the same MAC CE, has been indicated by a DCI, and the corresponding application time is not later than the default TCI application time (e.g., the default TCI activation time).

In some cases, there may be multiple default TCIs based on the same MAC CE activation command. Such TCI may be applied in order of activation, as illustrated in FIG. 7.

In some cases, a default TCI is determined based on the set of TCIs (activated by the same MAC CE) that have been activated so far. As an example, consider FIG. 8, in which four TCIs are activated by a MAC CE, each corresponding to a TCI codepoint. Not that a TCI index or TC state ID order might not be matched by a TC codepoint order. Such an order may be arbitrarily selected by the MAC CE, in various cases. In some cases, e.g., if a TC bitmap is used to indicate activated TCIs, a TCI index or TCI state ID order may translate into a TCI codepoint order, e.g., the activated TCI with lowest index/ID is mapped to the lowest TCI codepoint.

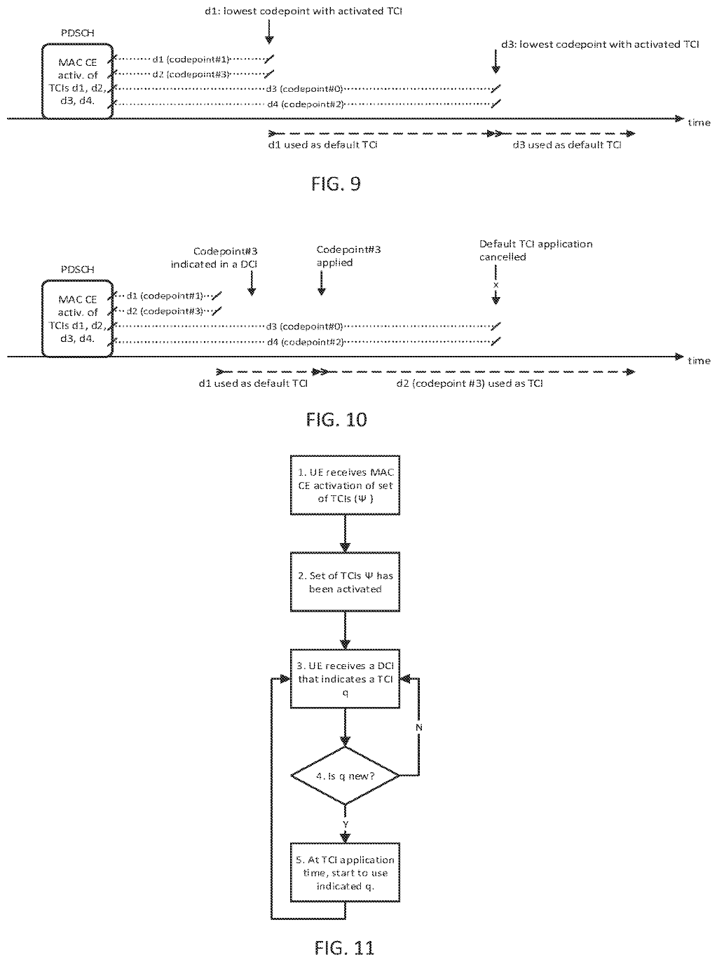

In some cases, as also discussed above, TCIs in a MAC CE activation command may be grouped based on the corresponding activation delays. In some cases, actual activation delays may be adjusted such that TCIs in a group have the same actual activation delay. In some cases, a default TCI is selected among TCIs in a such a group, based on indication in the MAC CE, configuration and/or a rule (e.g., lowest codepoint). This is illustrated in FIG. 9. For example, the first group (e.g., d1, d2) may include known TCIs or already activated known TCIs. The second group (e.g., d3, d4) may include unknown TCIs or not already activated known TCIs. The TCIs in the first group may be activated significantly earlier than the TCIs in the second group. By determining a default TCI already at the first activation time, a default TC is defined as early as possible. As more (groups of) TCIs are activated, they may be included in the default TCI determination.

In some cases, a default TC is determined only among the first group, which may comprise only one TCI, e.g., the first activated TCI becomes the default TCI.

In some cases, a default TC is determined only after all TCIs activated by a MAC CE have been activated. In other words, a default TCI might not be determined between the earliest activation time (e.g., d1 in FIG. 8) and the latest activation time (e.g., d4 in FIG. 8).

In some cases, some TC codepoints correspond to joint TCI while others correspond to separate TCI, e.g., a DL TC and a different UL TCI, or only a DL TCI, or only an UL TCI.

In some cases, a default TC is determined only among the joint TCI, e.g., the lowest TC codepoint with joint TCI.

In some cases, a default TCI is determined separately for DL TCI and for UL TCI. For example, the DL TCI in the lowest TC codepoint with a DL TC is selected as the default DL TCI. For example, the UL TCI in the lowest TC codepoint with an UL TCI is selected as the default UL TCI. In some cases, the default DL TC may be taken from a TCI codepoint corresponding to a joint TCI or a separate DL TCI. In some cases, the default UL TC may be taken from a TC codepoint corresponding to a joint TCI or a separate UL TCI.

In one example, the DL TC in the lowest TCI codepoint with a separate DL TCI is selected as the default DL TCI. In one example, the UL TCI in the lowest TC codepoint with a separate UL TCI is selected as the default UL TCI.

In some cases, a default DL TCI is applied at a different time than a default UL TCI, e.g., since the corresponding TCIs have different activation times.

As illustrated in FIG. 10, also the case with multiple default TCIs, e.g., with different default TCIs nominally being applied at different points in time may result in ambiguities if a TC (activated by the same MAC CE) with earlier activation time (e.g., d2) may be indicated by a TCI codepoint in a DCI before the activation time of a default TCI (e.g., d3). The corresponding application time (e.g., of d2) may be before or after the different default TCI activation times. In some cases, a default TCI is not applied if another TCI, activated by the same MAC CE, has been indicated by a DCI, and the corresponding application time is not later than the default TCI application time (e.g., the default TC activation time). However, for another (earlier) default TCI (e.g., d1), the application time corresponding to the TCI indicated by a TCI codepoint may be after the default TCI application/activation time, in which case it may be used.

According to some aspects, this solution may also be applicable in the case that no default TCI from the MAC CE has been applied at the time of application of a TCI corresponding to a TCI codepoint indicated in a TCI, but with a later default TCI, which in this case may be cancelled. In other cases, the later default TCI may be applied anyway, even if a TCI from the same MAC CE was already applied using a DCI indication.

In some cases, a DCI indicates a separate DL TCI or separate UL TCI, e.g., as illustrated in FIG. 10. For instance, consider the case with a separate UL TCI being indicated in a DCI, e.g., d2 by codepoint #3. Consequently, only the UL TC may be updated, which may mean that the default DL TCI remains in use also after the indicated TCI is applied. Furthermore, a later default UL TCI may be cancelled, similar as in FIG. 10. In some cases, also later default DL TCIs may be cancelled. In other cases, later default DL TCIs may still be applied after the indicated UL TCI has been applied.

In some cases, a default TCI may be a TCI that was activated in the MAC CE that was already activated. For example, if a currently used TCI (which is activated) is included in a MAC CE that activates a set of TCIs, the currently used TC may continue to be used, e.g., as a default TCI. In some cases (e.g., if the currently used TCI is not included in a MAC CE that activates a set of TCIs), a default TCI may be determined from a set of already activated TCIs (e.g., a TC mapped to a lowest or highest TCI codepoint).

In some cases, a default TCI is explicitly indicated in a MAC CE for TC activation. For example, a dedicated bit or a field providing an index among the activated TCIs can be used to indicate a default TCI.

In some cases, a DCI that schedules a PDSCH carrying a MAC CE for TCI activation indicates a default TCI. For example, a TCI codepoint in such a DCI may indicate a default TCI for the MAC CE for TCI indication carried by the scheduled PDSCH.

For a UE with multiple CORESET pool indices, a first MAC CE for TC activation may activate TCIs for CORESETs with a first CORESET pool index and transmissions scheduled or activated from a PDCCH received in a CORESET with the first CORESET pool index, e.g., where the transmissions may include PDSCH, PUSCH, PUCCH, SRS, etc. In such cases, one or more default TCI(s) may be applicable to the CORESETs and transmissions associated with the first CORESET pool index. For a second CORESET pool index, a second MAC CE for TC activation may be received by the UE. One or more default TCI(s) may be determined from the second MAC CE and may be applicable to CORESETs and transmissions associated with the second CORESET pool index.

### TCI Indication

There are various options in which a TCI can be indicated in a DCI. For example:
(1) a TC codepoint is indicated in a DCI also carrying a PDSCH scheduling assignment, e.g., DCI format 1_1 or 1_2;
(2) a TCI codepoint is indicated in a DCI with a format that supports carrying a PDSCH scheduling assignment, e.g., DCI format 1_1 or 1_2, but with the PDSCH scheduling assignment omitted from the DCI;
(3) a TCI codepoint is indicated in a DCI format that doesn't support the inclusion of a DL or UL scheduling assignment/grant, e.g., a new DCI format; or
(4) a TC codepoint is indicated in a DCI format that supports carrying an PUSCH scheduling grant (“UL DCI”), e.g., DCI format 0_1 or 0_2.

In some cases, a DCI indicates a TCI codepoint and a UE may determine based on prior configuration and/or information carried in a MAC CE activation if the indicated TCI codepoint corresponds to a joint TCI, a DL TCI and/or an UL TCI.

In some cases, a DCI that indicates a TCI codepoint may also indicate whether the corresponding TCI state is to be used as a joint TCI, a DL TCI and/or an UL TCI.

For example, a TCI codepoint indicated by an UL DCI may be used as an UL TCI.

In another example, a DC may indicate whether an indicated TCI state, e.g., a TC state that has been activated for the indicated TCI codepoint, is to be used as a joint TCI, DL TC and/or UL TCI, e.g., by using a DCI field for such an indication.

A basic procedure for the application of a TCI is shown in FIG. 11.

In step 1, a UE receives a MAC CE for TCI activation for the unified TCI state framework, activating a set of TCIs P. After some time, the TCIs have been activated, as in step 2. The UE performs PDCCH monitoring and receives DCIs in step 3. It receives a DCI that indicates a TCI q. In step 4, it is determined if the indicated TCI is new, e.g., that it not currently being used. If it is not new, a TCI update is not needed, and the UE can return to PDCCH monitoring in step 3. If the indicated TCI q is indeed new, the UE starts to use the indicated TCI q at the proper application time.

Various basic TCI application timelines are described in Basic TCI Application Timelines below. Several specific problems and solutions to the application timelines are discussed in Discussions on Enhanced TCI Application Timelines.

### Basic TCI Application Timelines

In some examples of TC application timeline, the reception time of a DCI is used as a reference point, e.g., the first or last symbol of a DCI. This may correspond to the first or last symbol of the PDCCH that carries the DCI or the first or last symbol of a PDCCH occasion in which the DCI was received. In case of PDCCH repetition in time, the reception time of a DCI may refer to the first or last symbol of the first PDCCH repetition in time, or the first or last symbol of the last PDCCH repetition in time. In some cases, the DCI reception time, refers to the slot or the span in which the DCI was received.

TC Application Alt 1

In one alternative of TCI application timeline, a TCI is applied a certain time after the reception of the DCI carrying the TCI codepoint indication. For example, a TC is applied in the first slot that is at least X ms or Y symbols after the first or last symbol of the DCI (or the corresponding PDCCH or PDCCH occasion).

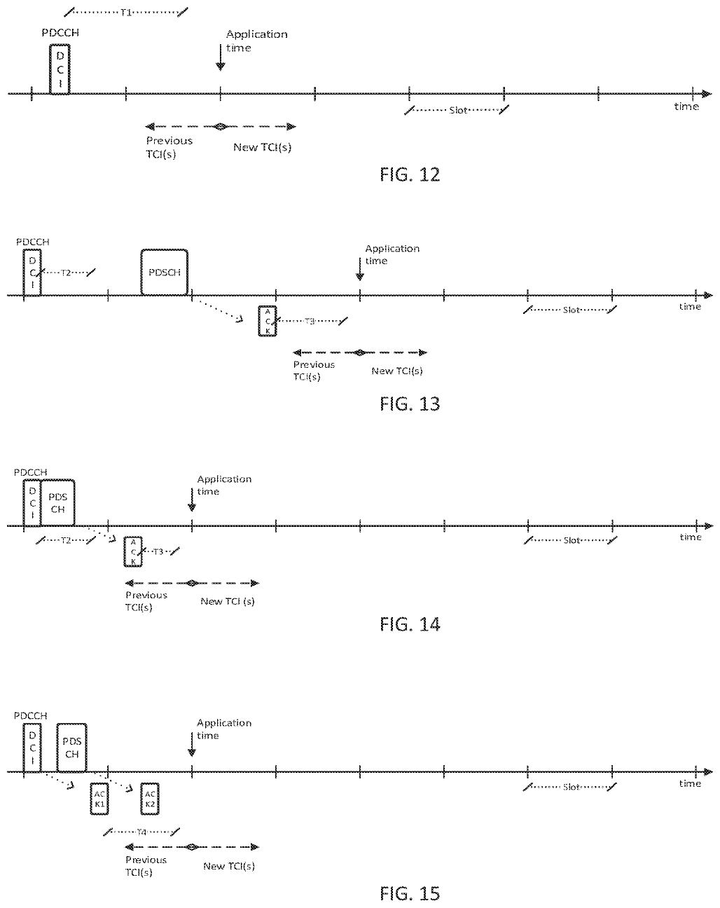

FIG. 12 shows an exemplary illustration of TCI application timeline Alt 1. A DCI carried by a PDCCH indicates new TCI(s), different from the previous TCI(s). A new TCI is applied during the first slot that is at least T1 (e.g., in ms or symbols) after the reception of the DCI.

Note that a DCI may indicate anew DL TC but not a new UL TCI, or a new UL TCI but not a new DL TCI, or a new DL TCI and a new UL TCI, or a new joint TCI. In some cases, the threshold T1 is different for these different cases, e.g., different for DL TC and UL TCI.

TCI Application Alt 2A

In one alternative of TC application timeline, a TC is applied a certain time after the acknowledgement of the DCI carrying the TCI codepoint. For example, a TCI is applied in the first slot that is at least X ms or Y symbols after the first or last symbol of the ACK (e.g., a PUCCH resource carrying the ACK).

In some cases, the acknowledgement of the DCI is transmitted jointly with the acknowledgement of the PDSCH scheduled by the DCI. In some cases, this means that an ACK or NACK to the PDSCH may imply an ACK of the DCI. The indicated beam may be applied if the UE transmitted ACK or NACK, but not if the UE didn't transmit ACK or NACK. In some cases, an ACK to the PDSCH may imply an ACK of the DCI while a NACK to the PDSCH may imply a NACK to the DCI. The indicated beam may be applied if the UE transmitted ACK, but not if the UE transmitted NACK.

FIG. 13 shows an exemplary illustration of TC application timeline Alt 2A. A DCI carried by a PDCCH indicates new TCI(s), different from the previous TCI(s). The new TCI(s) is applied during the first slot that is at least T3 (e.g., in ms or symbols) after the reception of the acknowledgement of the PDSCH scheduled by the DCI. This figure also includes the threshold T2, which in some examples may be identical to RRC parameter value timeDurationForQCL, if applicable, or some other value in other examples. In the example illustrated in FIG. 13, the time difference between the DCI and the PDSCH is greater than the threshold T2.

FIG. 14 also shows an exemplary illustration of TCI application timeline Alt 2A. In this example, the time difference between the DCI and PDSCH is smaller than the threshold T4. The beam can be applied earlier compared to the example in FIG. 13, already two slots after the slot in which the DCI was received.

In some cases, the ACK/NACK of the DCI is separate from the ACK/NACK of the PDSCH scheduled by the DCI. In some cases, e.g., if the DCI doesn't include a downlink scheduling assignment, there is no corresponding ACK/NACK of a PDSCH. In some cases, a separate ACK means that the UE successfully received and decoded the DCI. In some cases, a separate ACK means that the UE successfully received new TCI(s), e.g., different from the previous TCI(s), in the DCI. A UE may apply the indicated TCI after the transmission of the corresponding separate ACK.

FIG. 15 shows an exemplary illustration of a TC application timeline with an acknowledgement of the DCI (ACK1 in the figure) that is separate from the ACK/NACK or the PDSCH (ACK2 in the figure). In the example, the indicated TCI may be applied in the first slot that is at least T4 (e.g., in unit of ms or symbols) after the acknowledgement of the successful reception of the new TCI(s) (ACK1).

TC Application Alt 2B

In one alternative of TCI application timeline, a TCI is applied a certain time after the acknowledgement of the DCI carrying the TCI codepoint indication, except that it can, e.g., under some conditions, be applied to the PDSCH scheduled by the DCI and/or to an acknowledgement. An example of such a condition is that the time difference between the DCI and the PDSCH is greater than or equal to a certain threshold. The TCI may, e.g., under some conditions, be applied to a corresponding ACK, e.g., a PUCCH resource. An example of such a condition is that the time difference between the DCI and the acknowledgement is greater than or equal to a certain threshold. Beside the exception of the TC application to PDSCH and/or ACK, this alternative may follow Alt 2A discussed above.

For example, a TCI is applied to the first slot that is at least X ms or Y symbols after the first or last symbol of the ACK (e.g., a PUCCH resource carrying the ACK), except that the (new) TCI update may be applied to the PDSCH, if it exists, (scheduled by the beam indication DCI) and/or corresponding ACK transmission, e.g., provided that the time offset between the DCI and the scheduled PDSCH exceed the threshold. In some cases, an indicated TCI may be applied to the ACK transmission if the time difference between the DCI and the ACK is greater than or equal to a threshold, which may be different from the threshold used for PDSCH or the same. Some UE implementations may require more time to apply anew TC to an UL transmission than to a DL transmission. Other UE implementations may require less time or the same time.

In some cases, in which an indicated TCI is applicable to both DL and UL, e.g., a joint TCI, the TCI may be applied to the scheduled PDSCH and the ACK/NACK (e.g., on a PUCCH resource).

In some cases, in which the DCI indicates a TCI that is applicable to DL (DL TCI) and a TC state that is applicable to UL (UL TCI), e.g., separate DL/UL TCI, the DL TC may be applied to the scheduled PDSCH and the UL TCI may be applied to the ACK/NACK (e.g., on a PUCCH resource).

In some cases, in which the DCI indicates a TCI that is applicable to DL (separate DL TCI), but not to UL, the DL TCI may be applied to the scheduled but not to the ACK/NACK. Instead the previous UL TCI is applied to the ACK/NACK.

In some cases, in which the DCI indicates a TCI that is applicable to UL (separate UL TCI), but not to DL, the UL TCI may be applied to the ACK/NACK, but not to the scheduled PDSCH. Instead, the previous DL TCI is applied to the PDSCH.

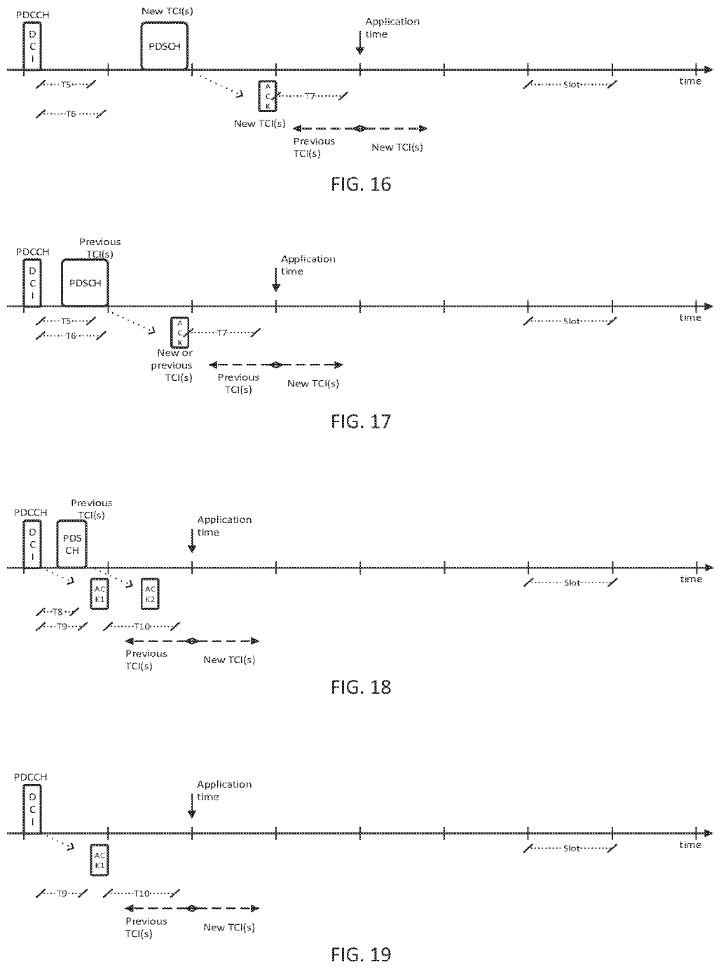

FIG. 16 shows an example of a TC application timeline in which the new TCI(s) is generally applied some time after the acknowledgement of the PDSCH scheduled by the DCI that indicates the new TCI(s). However, a new TC is also applied to the scheduled PDSCH and the corresponding ACK. A TCI applied to the ACK may be the same, e.g., in the case of joint TCI, or different, e.g., in the case of separate DL and UL TCI. The time difference between the DCI and the scheduled PDSCH is greater than the threshold T5, so the new TCI is applied also to the PDSCH. A new TCI is also applied to the ACK of the PDSCH. The example includes a time threshold T6, which may be used to determine whether an indicated TC is applied to the acknowledgement. In some cases, a separate threshold for the acknowledgement is not used, but instead the same threshold as for PDSCH is used, e.g., T5. The time threshold T7 illustrates the minimum time after the acknowledgement that the new TCI(s) is generally applied.

FIG. 17 is similar to FIG. 16, but the time difference between the DCI and the scheduled PDSCH is less than the threshold T5. In this case, the previous TCI(s) is applied to the PDSCH reception. The acknowledgement of the PDSCH, however, comes after the threshold (T5 in some cases and T6 in some cases). In this example, it is not clear whether to apply new TCI(s) to the ACK. In one approach, new TCI(s) is either applied to both the scheduled PDSCH and a corresponding acknowledgement or to neither of them. In other words, the previous TCI(s) is applied also to the ACK since it is applied to the PDSCH. This approach may for instance be used in the case of joint TCI. In another approach, a new TC is applied to the acknowledgement if the time difference between the DCI and the acknowledgement is greater than or equal to a threshold, e.g., T5 or T6 in the exemplary illustration in FIG. 17. This approach may for instance be used if separate DL and UL TCI is used, e.g., indicated in the DCI. Alternatively, the approach may be used regardless if joint or separate DL and UL TC is used, e.g., indicated in the DCI. In FIG. 17, the time difference is greater than a threshold, e.g., T5 or T6, so a new TC may be applied to the transmission of the acknowledgement. In the examples above, if a new TCI is not applied to the scheduled PDSCH or a corresponding ACK, a previous TCI is applied, be it joint of separate.

FIG. 18 shows an example of a TCI application timeline in which the new TCI(s) is generally applied some time after the transmission of an acknowledgement of a DCI carrying a TCI update (ACK1). Note that the acknowledgement of the DCI is separate from the acknowledgement of the PDSCH in this example. In some cases, the DCI doesn't include a DL assignment, so no PDSCH is scheduled by the DCI and not corresponding acknowledgement (ACK2) is needed, which is illustrated in FIG. 19. In FIG. 18, the time difference between the DCI and the scheduled PDSCH is less than the threshold so the previous TCI(s) (e.g., joint TC or DL TCI) is used for the PDSCH reception. However, in some cases, e.g., the examples illustrated in FIG. 18 and FIG. 19, a new TC (e.g., joint TC or UL TCI) is applied to ACK I if the time difference between the DCI and the acknowledgement (e.g., transmitted on a PUCCH resource) is greater than a threshold, such as T8 or T9.

Consider the case with a TCI codepoint mapped to two joint TCIs, e.g., for the purpose of repetition for reliability enhancement. In some cases, a DCI indicates such a TCI codepoint, schedules PDSCH with repetition, but indicates a PUCCH resource without repetition. The ACK may also be carried by a PUSCH without repetition. In this case, the UE may apply both TCIs to the PDSCH transmission, but only one TCI to the UL transmission carrying the ACK. The UE may select one of the TCIs mapped to the TCI codepoint, e.g., the TC state that was indicated first in the activation MAC CE, or the TCI with the lowest TC state ID.

TCI Application Alt 2C

In some cases, a UE may support one or multiple TC application timelines. In one example, a UE may support one or both of Alt 1, Alt 2A. In various other examples, A UE may support other one or multiple TCI application timeline(s), e.g., incl. Alt 2B and/or Alt 3.

A UE may indicate its capability to the network, e.g., using UE capability signaling on the RRC layer. In some cases, e.g., if the UE indicated support of one TCI application timeline, the UE may assume that the indicated timeline is to be used. In some cases, incl. if the UE has indicated support for one or multiple timelines, the UE may assume that a TC application timeline is used after the gNB has configured the UE. e.g., using RRC configuration, to use a certain TCI timeline.

TCI Application Alt 3

In some cases, a UE supports a TCI application timeline that provides both sufficient application time after the reception of the DCI as well as sufficient time after the transmission of the acknowledgement.

For example, a TCI is applied in the first slot that is at least X1 ms or Y1 symbols after the first or last symbol of the DCI with beam indication and X2 ms or Y2 symbols after the first or last symbol of the acknowledgment of the TCI indication.

Note that in some cases, the acknowledgement of the TCI indication is also the acknowledgement of the PDSCH scheduled by the DCI, while in some cases, it is separate.

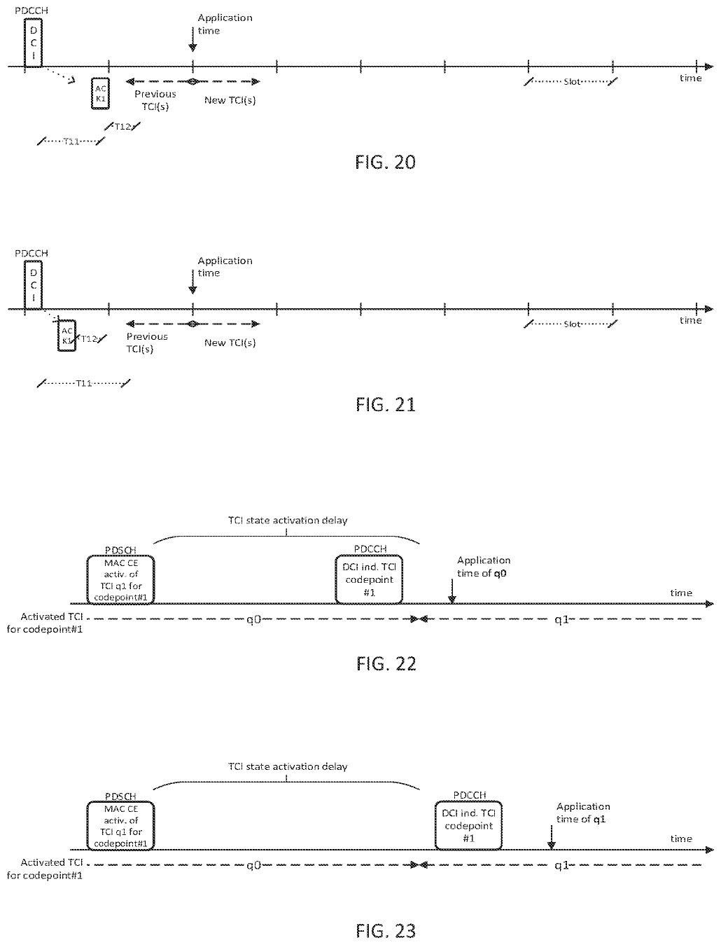

FIG. 20 and FIG. 21 illustrate examples of Alt 3. In FIG. 20, the first slot that is T11 (ms or symbols) after the DCI is one slot earlier than the first slot that is T12 (ms or symbols) after the acknowledgement. Since the new TCI(s) is applied in the first slot that fulfills both conditions, it is applied in the latter of the two slots. Similarly, in FIG. 21, the first slot that is T11 (ms or symbols) after the DCI is one slot later than the first slot that is T12 (ms or symbols) after the acknowledgement. Since the new TCI(s) is applied in the first slot that fulfills both conditions, it is applied in the latter of the two slots.

### Discussions on Enhanced TC Application Timelines

TCI Application Upon TCI Activation

As discussed above, the TC signaling to a UE may be a multi-step procedure, which may first involve RRC signaling of one or more pools of TC states, secondly activation of one or more TCIs as well as mapping to TC codepoints by MAC CE, and thirdly indication of one or more TCIs using a DCI.

The first step may be assumed to be performed infrequently since a UE may be configured with a large number of TC states in most cases.

However, the second step (MAC CE activation) may have to be performed relatively frequently, depending on several factors. For example, some UEs may support a smaller number of activated TCI states (e.g., 2, 4 or 6) than what the DCI signaling allows (e.g., 8). Furthermore, some scenarios, e.g., high frequency bands, may utilize narrow beams. This may imply that a relatively small UE movement may require a new set of activated TCI states, which may correspond to different beams. Naturally, high-speed UEs may also require frequent activation of new TCI states. The potential relatively frequent TCI activation by MAC CE is an argument to improve the efficiency and interaction between the TCI activation (MAC CE) and application (DCI) timelines.

Two basic principles may be considered.

Principle 1: The DCI to indicate a TC can be transmitted after the TCI has been activated.

This is illustrated in FIG. 22 and FIG. 23

Principle 2: The DCI to indicate a TCI can be transmitted before the TC has been activated if the TCI has been activated at the application time.

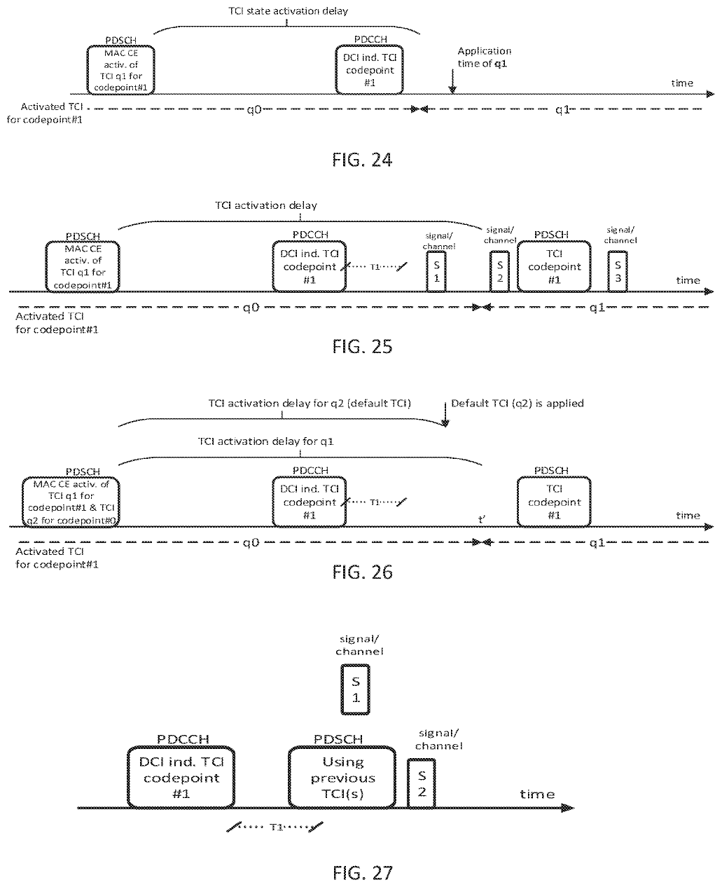

This is illustrated in FIG. 24.

In FIG. 22 and FIG. 23, an exemplary illustration of principle 1 is shown, focusing on the activation and indication of a TCI mapped to TCI codepoint #1. A MAC CE activates TC q1 and maps it to TCI codepoint #1. Previously, another TC q0 has been activated and mapped to this TCI codepoint. In FIG. 22, the DCI is received prior to the activation time. Hence, the indicated TCI codepoint #1 is interpreted to refer to TCI q0, which is therefore applied at the corresponding application time. In FIG. 23, the DCI is received after the activation time, which means that the indicated TCI codepoint #1 is interpreted to refer to the newly activated TCI q1.

In FIG. 24, an exemplary illustration of principle 2 is shown, again focusing on the activation and indication of a TCI mapped to TCI codepoint #1 The DCI is received prior to the activation time. However, the indicated TC is to be applied later than the reception of the DCI. In this example, the application time is after the activation time. Hence, according to principle 2, the indicated TC codepoint #1 is interpreted to refer to the newly activated TCI q1, which is therefore applied at the corresponding application time.

Comparing these two principles, principle 2 results in the lowest latency between activation command (in MAC CE) and corresponding application time. Hence, principle 2 may be generally assumed herein, unless otherwise noted.

TCI Application—Further Enhancements

According to some aspects. TCI application timelines were discussed supra. Various further issues and solutions are discussed here.

First, consider the exemplary illustration in FIG. 25. Similar to previous figures, an arbitrary TCI codepoint may be considered, in this example it is TCI codepoint #1. A TC activation MAC CE is received, which activates a TC q1 for this codepoint. Previously, a TC q0 was activated and mapped to this codepoint. Following the MAC CE, there is a certain TC activation delay for q1. The TCI codepoint is indicated by a DCI received prior to the time of activation. The DCI (e.g., format 1_1 or 1_2) schedules a PDSCH after the activation time. There are other signals/channels after the TCI application threshold T1, labeled 1, 2, and 3. It is assumed that the common beam operation is applicable to these signals/channels. For example, they represent CORESETs in which the UE monitors PDCCH. In another example, e.g., if an indicated TCI is a joint TC or an UL TCI, the signals/channels may for instance represent PUCCH resources, SRS or PUSCH.

It is assumed that q1 is different from q0. The TCI application threshold (e.g., T1 in FIG. 25) may correspond to different values in different cases and different alternatives. In one example based on Alt 1, the application threshold may correspond to a time after the DCI, (e.g., T1, as illustrated in FIG. 25). In one example based on Alt 2A, the application threshold may correspond to a time after an ACK (e.g., T4). In one example based on Alt 2B, the application threshold may correspond to a time after an ACK (e.g., T10). In one example based on Alt 3, the application threshold may correspond to a time after a DCI or a time after an ACK, whichever gives the later application time (e.g., T11 or T12).

The TCI application in this situation may be ambiguous and may need a solution. According to some embodiments, a few options are presented below.

Option 1: The TCI codepoint #1 indicated in the DCI refers to q0. TCI q0 is applied to S1, S2, the scheduled PDSCH and S3.

Option 2: The TCI codepoint #1 indicated in the DCI refers to q0 for S1, but q1 for S2, the scheduled PDSCH and S3.

Option 3: The TCI codepoint #1 indicated in the DCI refers to q0 for S1 and S2, but q1 for the scheduled PDSCH and S3.

Option 4: The TCI codepoint #1 indicated in the DCI refers to q1 for S2, the scheduled PDSCH and S3. The DCI doesn't impact the TCI of S1, even though it is after the application threshold (e.g., T1).

Option 5: The TCI codepoint #1 indicated in the DCI refers to q1 for the scheduled PDSCH and S3. The DCI doesn't impact the TCI of S1 and S2, even though they are after the application threshold (e.g., T1).

Option 1 generally follows both principle 1 and principle 2 discussed above. A drawback is that application of q1 is not applied as early as possible. However, this may require redefining the legacy TCI rule for PDSCH as follows.

When the UE is configured with a single slot PDSCH and the time offset between the reception of the DL DCI (or the transmission of the ACK, depending on the alternative) and the corresponding PDSCH is equal to or greater than a threshold (e.g., T1), the indicated TCI (or TCI state) should be based on the activated TCIs (or TCI states) in the first slot in which the indicated TCI (or TCI state) is applicable. When the UE is configured with a multi-slot PDSCH and the time offset between the reception of the DL DCI (or the transmission of the ACK, depending on the alternative) and the corresponding first PDSCH is equal to or greater than a threshold (e.g., T1), the indicated TCI state should be based on the activated TCIs (or TCI states) in the first slot in which the indicated TCI (or TCI state) is applicable, and UE shall expect the activated TCI states are the same across the slots with the scheduled PDSCH.

Option 2 follows the legacy TCI rule for PDSCH, e.g., that an indicated TCI codepoint is interpreted based on the activated TCIs (or TCI states) in the slot of the PDSCH. A benefit is that TCI q1 can be used as early as possible, e.g., already for S2. A drawback is that the same DCI with an indication of a TCI codepoint may refer to two different TCIs, depending on if the slot containing the signal/channel is before or after the activation time.

Option 2 may be worded as follows in some cases.

When a UE receives a DCI that indicates a new TCI codepoint with an application time in a slot before the corresponding TCI is activated, and that schedules a PDSCH in a slot after the corresponding TCI is activated, the indicated TCI used for a signal/channel after time the application threshold (e.g., after time T1) and until the slot of the scheduled PDSCH, should be based on the activated TCIs in the slot containing the signal/channel.

Option 3 has similar drawbacks as Option 2, but the TCI switch happens with the scheduled PDSCH instead of upon TCI state activation. It could for example be worded as follows:

When a UE receives a DCI that indicates a new TCI codepoint with an application time in a slot before the corresponding TCI is activated, and that schedules a PDSCH in a slot after the corresponding TCI is activated, the indicated TCI used for a signal/channel after the application threshold (e.g., after time T1) and until the slot before the slot of the scheduled PDSCH, should be based on the activated TCIs in the slot containing the DCI. The indicated TCI used for the slot of the scheduled PDSCH and subsequent slots (until the next TCI update) should be based on the activated TCI state in the slot of the scheduled PDSCH.

Option 4 has both the advantage of single DCI indicating a single TCI and the advantage of early TCI application upon activation. The signal/channel S1 is after the application threshold (e.g., after the threshold T1), so its TCI would normally have been updated by the TCI indicated by the DCI. However, since the scheduled PDSCH is after the activation time of the indicated TCI (and the TCI is different), S1 would use the previous TCI, e.g., that was applicable before the reception of the DCI. This could for instance be worded as follows.

When a UE receives a DCI that indicates a new TCI codepoint with an application time in a slot before the corresponding TCI is activated, and that schedules a PDSCH in a slot after the corresponding TCI is activated, the indicated TCI is not used for signals/channels in slots before the activation time.

Option 5 is similar to option 4, but the new TCI is not applied until the scheduled PDSCH. This could be worded as follows.

When a UE receives a DCI that indicates a new TCI codepoint with an application time in a slot before the corresponding TCI is activated, and that schedules a PDSCH in a slot after the corresponding TCI is activated, the indicated TCI is not used for signals/channels in slots before the slot of the PDSCH.

Note that the options above may be combined with a default TCI state following MAC CE based activation, for instance Option 4 and Option 5, in which the TCI codepoint indicated by a DCI is not used prior to the activation time. In some cases, there may be an ambiguity that may need to be solved on which TCI that takes precedence: a default TCI or a TCI indicated before the default TCI was applied. As an example, consider FIG. 26. A MAC CE command is received in which TCIs are activated, including TCI q1 (mapped to TCI codepoint #1) and TCI q2 (mapped to codepoint #0). Assume that q2 is the default TCI and that it is applied (as a common beam TCI) upon activation of q2. In this example, however, a DCI indicates TCI codepoint #1 with application time prior to the application of the default TCI. In another example, the application time may be after the application of the default TCI. The DCI also schedules a PDSCH, and under normal conditions (e.g., no involvement of TCI activation or default TCI), the TCI indicated in the DCI would be used for the PDSCH.

According to some aspects, the discussion and solutions described here are applicable also to other examples, e.g. examples in which Alt 2A, 2B, 2C, or 3 are used. A difference may be how the application time is determined, e.g., a certain time after the DCI or after an ACK, etc. Another difference may be, for example for 2A, that the scheduled PDSCH is prior to the activation time, but the ACK or the application time is after the activation time, e.g., t′. In the case of TCI indication using a DCI without scheduling grant, the ACK or the application time may be after the activation time.

The TCI application after the activation of q1 (at time t′) may be ambiguous and may need a solution. It may be assumed that the default TCI (q2) is used at least between the activation time of q2 and t′, given that the activation of q2 is earlier. For the case that t′ is concurrent or earlier than the activation of q2, this might not be assumed. A few options are presented below.

Option 1: Default TCI (q2) is used also after t′.

Option 1-1: Default TCI is used also for the PDSCH.

Option 1-2: The indicated TCI q1 is used for PDSCH, but not for other signals/channels.

Option 2: The indicated TCI q1 is used for signals/channels after t′.

In option 1, the default TCI is prioritized over the TCI indicated in the DCI. This rule could for instance be formulated as follows.

A signal/channel in a slot n uses an indicated TCI with latest application time until slot n−1 or default TCI with latest activation time until slot n−1, whichever is latest. Option 1-2 could add the exception of a PDSCH after the default TCI activation time that was scheduled by a DCI before the default TCI activation time.

In option 2, the indicated TCI q1 is prioritized over the default TCI.

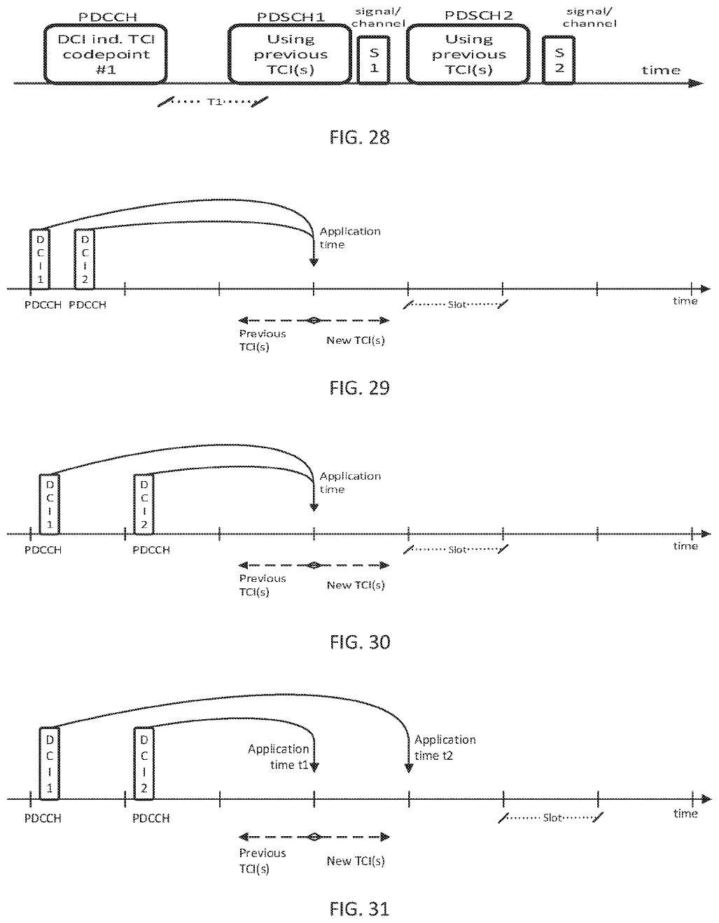

Second, consider the exemplary illustrations in FIG. 27 and FIG. 28. A DCI indicates an arbitrary activated TCI codepoint, in this example codepoint #1. Following the principle of Alt 1, the indicated TCI may be applicable after a delay of T1. The same DCI also schedules a PDSCH, which happens to start before the application time. In case of a multi-slot PDSCH transmission scheduled by the DCI (e.g., FIG. 28), the first PDSCH transmission (e.g., PDSCH1 in FIG. 28) happens to start before the application time. Assume that the DCI indicates a TCI that is different from the previously used TCI. The TCI indicated by the DCI is not used for receiving the PDSCH(s) since the time difference is too small. Instead, the previous TCI is used. In the case of multiple repeated PDSCHs, the previous TCI(s) may be used if the time difference to the first PDSCH is too small, also for the PDSCH repetitions with individual time differences greater than the threshold (e.g., PDSCH2 in FIG. 28). There are also signals/channels S1 and S2 for which the common TCI is used (see example signals/channels above). Both S1 and S2 are after the TCI application time, e.g., the time difference between the DCI and the signal/channel is greater or equal to a threshold (T1 in this example).

The TCI application in this situation may be ambiguous and may need a solution. A few options are discussed below.

Considering S1 by itself, the TCI indicated in the DCI should be applied since the time difference between the DCI and S1 is greater than the threshold. However, an exception may be needed for this case. In FIG. 27, S1 may be received on symbols used for also receiving the PDSCH using the previous TCI(s), which may prohibit a UE to receive the PDSCH with one TCI and S1 with another TCI, in particular in a frequency range in which spatial QCL is applicable, such as FR2. In this case, it may be better to use the previous TCI(s) also for S1. In other cases, such as if the UE can apply different TCI states to the same received symbol, e.g., in FR1, the UE may apply the new TCI to S1.

An exception may for example be formulated as follows.

If the time difference between the latest DCI (that indicates a new TCI) and a signal/channel is greater than or equal to a threshold (e.g., T1), a UE shall use the indicated TCI for the signal/channel, except if the signal/channel is received in the same symbol as another signal/channel (e.g., a PDSCH scheduled by the same DCI) using a previous TCI with a different QCL-TypeD source RS than the QCL-TypeD source RS in the TCI indicated by the latest DCI.

For the example illustrated in FIG. 28, S1 may not be in the same symbol as a PDSCH scheduled by the DCI, but between two of the repetitions. Note that S1 may also be an UL signal/channel. In a first option, the TCI indicated by codepoint #1 is used for S1, even though the previous beam is applied to a PDSCH repetition afterwards. This may result in extra beam switching, but may be feasible in some cases. In a second option, the TC indicated by codepoint #1 is not generally applied, e.g., incl. to S1, until after the PDSCH(s) have been received using the previous TCI(s).

An exception may for example be formulated as follows:

A TC indicated by a TCI codepoint in a DCI is applied to signals/channels that start at least a certain time after the DCI, unless the previous TCI(s) is applied to one or more PDSCH(s) that are scheduled by the DCI (e.g., since the time difference between the DCI and the start of the PDSCH(s) is too small), then the TCI indicated by the TCI codepoint in the DCI is applied after the PDSCH(s), e.g., the first slot after the last PDSCH.

Now, consider S2 in FIG. 27 and FIG. 28. Considering S2 by itself, the TC indicated in the DCI should be applied since the time difference between the DCI and S2 is greater than the threshold. Furthermore, S2 is after the PDSCH(s) scheduled by the DCI, so the exception above might not apply. However, in the case that S2 is in the same slot as the last PDSCH, the exception to apply the previous TCI(s) may be used for this case as well. This may be captured by the previous exception.

Multiple DCIs with Same or Out-of-Order TCI Application Time

In some cases, a UE may receive multiple DCIs in a slot, e.g., in different symbols and/or in different serving cells, with multiple TC codepoint indications. The multiple TCIs may have the same application time, e.g., a subsequent slot. This is illustrated in FIG. 29. This situation may result in ambiguity that may need to be resolved.

In some cases, the multiple DCIs are received in different cells. As such, they be received with different numerologies, e.g., subcarrier spacing and slot duration.

According to some aspects, the multiple DCIs considered here are such DCIs that carry may carry TCI indication(s) for the common TCI operation (unified TCI framework). For example, they are received in serving cells to which the common beam operation applies.

In some cases, multiple DCIs may be received simultaneously, e.g., in the same or in different cells. It may be required by the specification that such DCIs indicate the same TCI(s). In other cases, a UE may select one of the DCIs to determine which TCI(s) to apply, e.g. DCI received in serving cell with lowest serving cell index, and/or DCI received in CORESET or search space set with lowest index.

In some cases, DCIs received in different slots may also have the same TCI application time, as illustrated in FIG. 30. This case is similar and may also need to be addressed.

In general, it may be beneficial to use the information transmitted by the gNB at the latest point in time since the gNB may have better information at that point in time. However, there may be issues from an implementation standpoint to interrupt a TCI switching procedure at the UE that was initiated by an early DCI, e.g., if the TCI switching involves UE panel power-up etc.

In one approach, there is a constraint imposed by the specification that all relevant TCI indications in DCIs in a slot. e.g., TCI indications that are for TC state update in the unified TC framework, need to indicate the same TCI codepoint. In some cases, there is a constraint imposed that all relevant TCI indications that have the same application time, e.g., the same slot, need to indicate the same TCI codepoint, even if the DCIs are received in different slots.

In another approach, if a UE receives multiple DCIs that indicate different TC codepoints with application time in the same slot, then UE chooses one of the DCIs. In one example, the UE may choose the DCI that was received first (e.g., first starting or ending symbol). In another example, the UE may choose the DC that was received last (e.g., last starting or ending symbol).

In another approach, the UE may choose the DCI that was acknowledged first (e.g., first starting or ending symbol of nominal PUCCH resource), or the DCI that was acknowledged last (e.g., first starting or ending symbol of nominal PUCCH resource).

In some cases, the DCIs with the same application time indicate different kind of TCIs, e.g., a first DCI indicates a separate DL TCI and a second DCI indicates an UL TCI. In such cases, both TCIs may be applied. In some cases, a first DCI indicates a joint TC and a second DCI indicates a separate UL TCI. In such a case, the DL TCI (e.g., derived from the joint TCI) from the first DCI may be applied as well as the separate UL TCI from the second DCI.

In some cases, a default TC has the same application time (e.g., the activation time of the default TCI) as a TCI indicated by a DCI. The indicated TC may also correspond to a TCI activated by the same MAC CE as the default TCI. In some cases, the default TCI is applied instead of the indicated TCI. In some cases, the indicated TC is applied instead of the default TCI. In some cases, the indicated TC may be either separate UL TC or separate DL TCI. In this case, the indicated TCI (e.g., separate UL TCI) may be applied as well as a part of a default TCI, for example, a DL TCI (e.g., a separate DL TCI or a DL part of a joint TCI).

In some cases, out-of-order TCI application may occur. For example, a first DCI indicating a first TCI is received before a second DCI indicating a second TCI (e.g. in an earlier slot) while the application time of the second TCI is before the application of the first TCI. FIG. 31 shows an exemplary illustration of multiple DCIs with out-of-order TCI application time.

According to some aspects, a reason for out-of-order TCI application may be different for different application time alternatives, e.g., as discussed infra. For example, in Alt 2A or 2B, the application time may depend to the time difference between the DCI and the scheduled PDSCH, the duration of the scheduled PDSCH (which may span multiple slots), and the time difference between the PDSCH and the corresponding acknowledgement. These time differences may be indicated in the corresponding DCIs (e.g., through the ‘Time domain resource assignment’ field and/or the ‘PDSCH-to-HARQ_feedback timing indicator’ field) and may therefore be different for different DCIs.

In some cases, TCI update using a DCI with a scheduling assignment (e.g., for PDSCH or for PUSCH) is supported as well as using a DCI without a scheduling assignment. For the case without a scheduling assignment (or for the case with a DCI carrying an UL grant), there may be a separate acknowledgement to the DCI, e.g., an acknowledgement not corresponding to a PDSCH. It could be expected that an acknowledgement to a successfully decoded DCI could be transmitted by a UE faster than an acknowledgment to a successfully decoded DCI and successfully decoded subsequent PDSCH.

The network and UE assumption on TCI application may be ambiguous in such cases as described above, e.g., as illustrated in FIG. 31. Example solutions are given below, which may be used separately or in combination.

Example 1: Out-of-order TCI application times may be prohibited by the specification.

Example 2: For a successfully decoded second DCI that indicates a TCI with a second application time, override (or cancel) TCIs indications with later application time that were received in earlier DCIs. If the second DCI indicates separate TCI, e.g. UL TCI or DL TCI, only override (or cancel) TCI indications for the same (separate TCI). For instance, if the second DCI indicates an UL TCI and an earlier DCI also indicated an UL TCI but with a later application time, the UE does not apply the UL TCI at the later application time. According to some aspects, the same principle may be applied to the DL and/or UL part(s)s of a joint TCI.

Example 3 (e.g., may be equivalent to example 2 in some cases): At the application time of a first TCI, if a TCI from a later DCI has already been applied (e.g., as in FIG. 31 at time t2) the first TCI is not applied. Otherwise, the first TCI is applied. Note that, as in example 2, the consideration above may apply separately for UL TCI and DL TCI. In one example, at the application time of a first separate UL TCI, if a separate UL TCI from a later DCI has already been applied (e.g. as in FIG. 31 at time t2), the first separate UL TCI is not applied. In one example, at the application time of a first separate UL TCI, if a separate UL TCI (or a joint TCI) from a later DCI has already been applied (e.g., as in FIG. 31 at time t2), the first separate UL TCI is not applied. The same principle can be applied to the DL and/or UL part(s) of a joint TCI.

Example 4: The different TCIs, corresponding to different successfully decoded DCIs are applied in order of application time, regardless if the corresponding DCIs were received in a different order.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which may be also referred to as “32G”, 3GPP NR standards development may be expected to continue and include the definition of next generation radio access technology (new RAT), which may be expected to include the provision of new flexible radio access below 7 GHz, and the provision of new ultra-mobile broadband radio access above 7 GHz. The flexible radio access may be expected to consist of a new, non-backwards compatible radio access in new spectrum below 7 GHz, and it may be expected to include different operating modes that may be multiplexed together in the same spectrum to address a broad set of 3GPP NR use cases with diverging requirements. The ultra-mobile broadband may be expected to include cmWave and mmWave spectrum that may provide the opportunity for ultra-mobile broadband access for, e.g., indoor applications and hotspots. In particular, the ultra-mobile broadband may be expected to share a common design framework with the flexible radio access below 7 GHz, with cmWave and mmWave specific design optimizations.

3GPP has identified a variety of use cases that NR may be expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

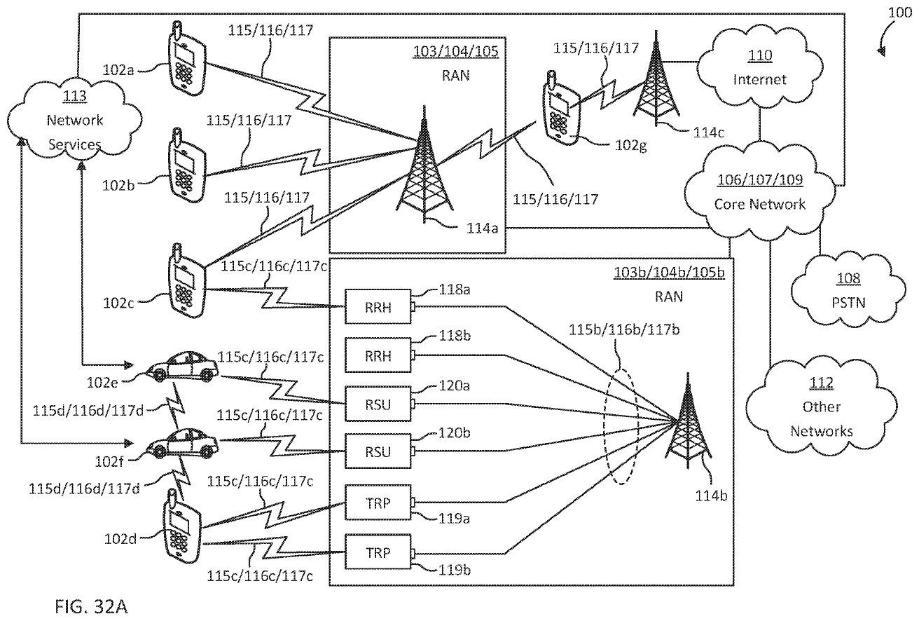

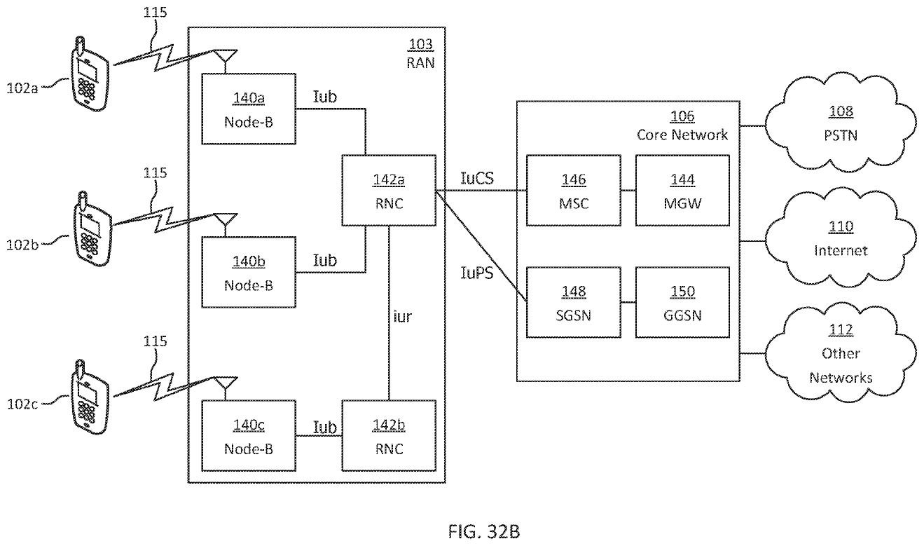

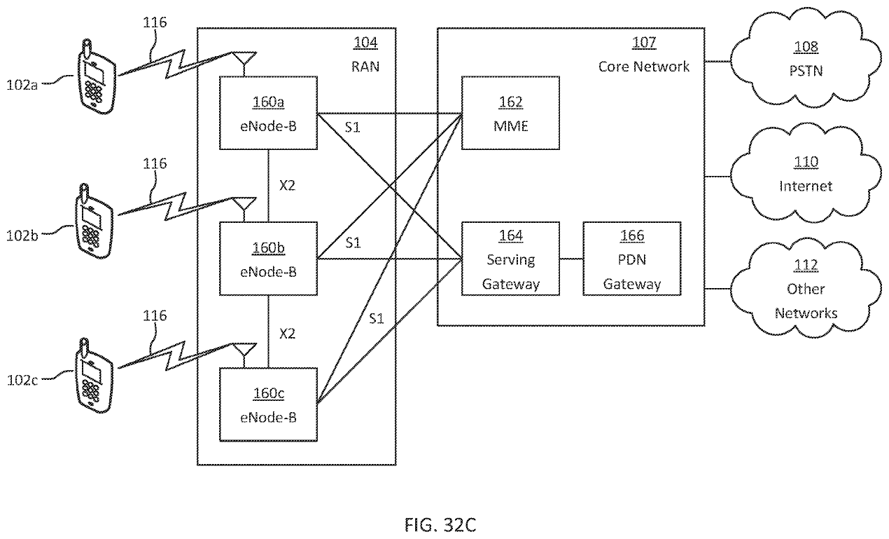

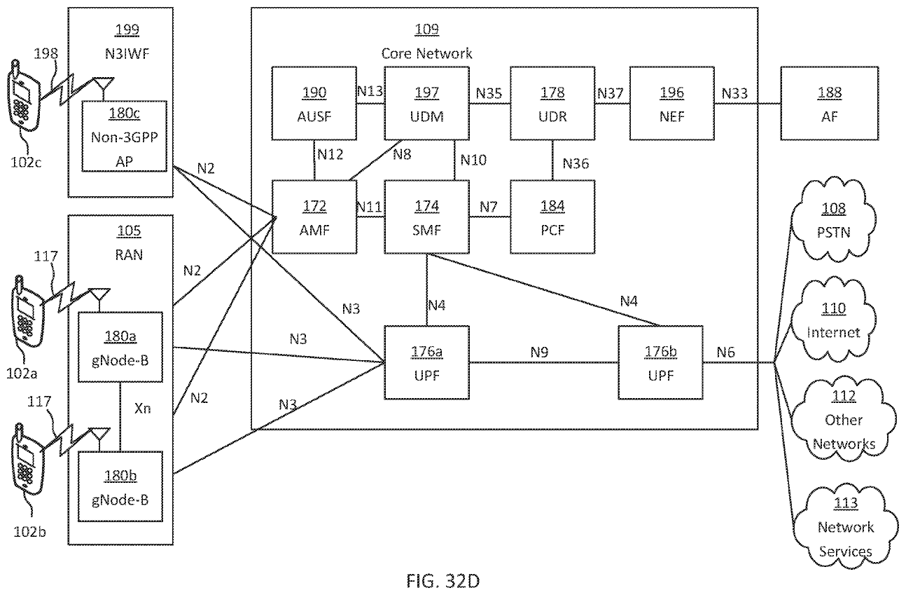

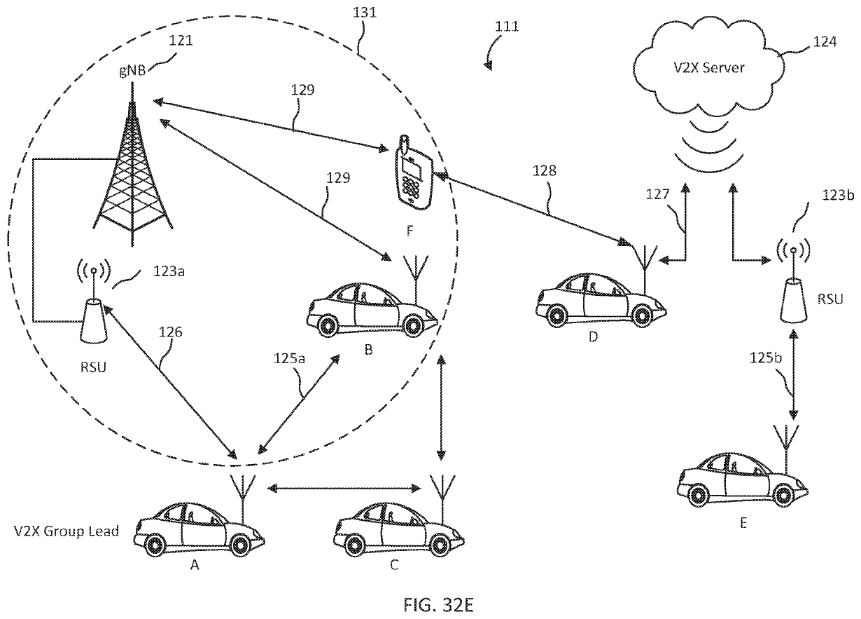

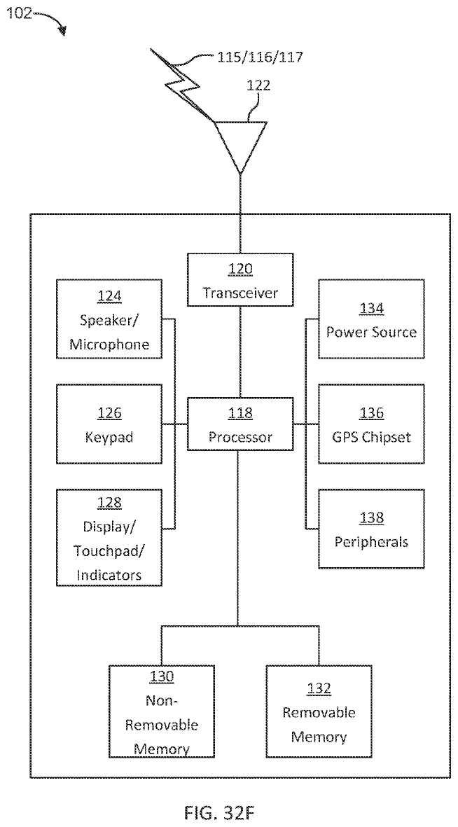

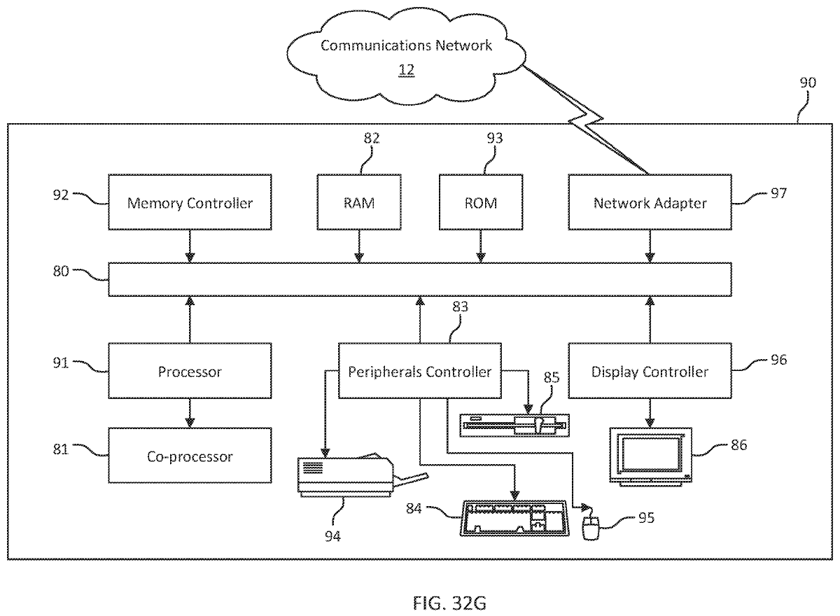

FIG. 32A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/1032B, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 32A, each of the WTRUs 102 may be depicted in FIGS. 8A-8E as a hand-held wireless communications apparatus. It may be understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 32A, each base stations 114a and 114b may be depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 1132A, 1132B, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 1132A, 1132B may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/1032B, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 1132A and 1132B, and/or RSUs 120a and 120b, over a wired or air interface 1132B/116b/117b, which may be any suitable wired (e.g., cable, optical fiber, etc.) or wireless communication link (e.g., RF, microwave, IR, UV, visible light, cmWave, mmWave, etc.). The air interface 1132B/116b/117b may be established using any suitable RAT.

The RRHs 118a, 118b, TRPs 1132A, 1132B and/or RSUs 120a, 120b, may communicate with one or more of the WTRUs 102c, 102d, 102e, 102f over an air interface 1132C/116c/117c, which may be any suitable wireless communication link (e.g., RF, microwave, IR, ultraviolet UV, visible light, cmWave, mmWave, etc.) The air interface 1132C/116c/117c may be established using any suitable RAT.

The WTRUs 102 may communicate with one another over a direct air interface 1132D/116d/117d, such as Sidelink communication which may be any suitable wireless communication link (e.g., RF, microwave, IR, ultraviolet UV, visible light, cmWave, mmWave, etc.) The air interface 1132D/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 1132A, 1132B and/or RSUs 120a and 120b in the RAN 103b/104b/1032B and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 1132C/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 1132A and 1132B, and/or RSUs 120a and 120b in the RAN 103b/104b/1032B and the WTRUs 102c, 102d, may implement a radio technology such as Evolved UMTS Terrestrial Radio Access (E-UTRA), which may establish the air interface 115/116/117 or 1132C/116c/117c respectively using Long Term Evolution (LTE) and/or LTE-Advanced (LTE-A), for example. The air interface 115/116/117 or 1132C/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b. TRPs 1132A and 1132B, and/or RSUs 120a and 120b in the RAN 103b/104b/1032B and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856). Global System for Mobile communications (GSM), Enhanced Data rates for GSM Evolution (EDGE), GSM EDGE (GERAN), and the like.

The base station 114c in FIG. 32A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 32A, the base station 114c may have a direct connection to the Internet 110. Thus, the base station 114c may not be required to access the Internet 110 via the core network 106/107/109.

The RAN 103/104/105 and/or RAN 103b/104b/1032B may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 32A, it may be appreciated that the RAN 103/104/105 and/or RAN 103b/104b/1032B and/or the core network 106/107/109 may be in direct or indirect communication with other RANs that employ the same RAT as the RAN 103/104/105 and/or RAN 103b/104b/1032B or a different RAT. For example, in addition to being connected to the RAN 103/104/105 and/or RAN 103b/104b/1032B, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/1032B or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 32A may be configured to communicate with the base station 114a, which may employ a cellular-based radio technology, and with the base station 114c, which may employ an IEEE 802 radio technology.

Although not shown in FIG. 32A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 1132C/116c/117c may equally apply to a wired connection.

FIG. 32B may be a system diagram of an example RAN 103 and core network 106. As noted above, the RAN 103 may employ a UTRA radio technology to communicate with the WTRUs 102a. 102b, and 102c over the air interface 115. The RAN 103 may also be in communication with the core network 106. As shown in FIG. 32B, the RAN 103 may include Node-Bs 140a, 140b, and 140c, which may each include one or more transceivers for communicating with the WTRUs 102a. 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 32B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it may be connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 32B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 32C may be a system diagram of an example RAN 104 and core network 107. As noted above, the RAN 104 may employ an E-UTRA radio technology to communicate with the WTRUs 102a. 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 32C, the eNode-Bs 160a, 160b, and 160c may communicate with one another over an X2 interface.

The core network 107 shown in FIG. 32C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data may be available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 32D may be a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 32D, the gNode-Bs 180a and 180b may communicate with one another over an Xn interface, for example.

The core network 109 shown in FIG. 32D may be a 32G core network (32GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It may be understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 32G.

In the example of FIG. 32D, the 32G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 32G core network 109, it may be appreciated that any one of these elements may be owned and/or operated by an entity other than the core network operator. It may also be appreciated that a 32G core network may not consist of all of these elements, may consist of additional elements, and may consist of multiple instances of each of these elements. FIG. 32D shows that network functions directly connect to one another, however, it should be appreciated that they may communicate via routing agents such as a diameter routing agent or message buses.

In the example of FIG. 32D, connectivity between network functions may be achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface may not be shown in FIG. 32D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 32G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 32D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that may be in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 32G core network 109 to Application Functions (AF) 188. Exposure may occur on the N33 API interface. The NEF may connect to an AF 188 via an N33 interface and it may connect to other network functions in order to expose the capabilities and services of the 32G core network 109.

Application Functions 188 may interact with network functions in the 32G Core Network 109. Interaction between the Application Functions 188 and network functions may be via a direct interface or may occur via the NEF 196. The Application Functions 188 may be considered part of the 32G Core Network 109 or may be external to the 32G Core Network 109 and deployed by enterprises that have a business relationship with the mobile network operator.

Network Slicing may be a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 32G core network to support Network Slicing. Network Slicing may be a good tool that network operators may use to support the diverse set of 32G use cases (e.g., massive IoT, critical communications, V2X, and enhanced mobile broadband) which demand very diverse and sometimes extreme requirements. Without the use of network slicing techniques, it may be likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 32D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 32G core network 109 and a PSTN 108. For example, the core network 109 may include, or communicate with a short message service (SMS) service center that facilities communication via the short message service. For example, the 32G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 8A, 8C, 8D, and 8E are identified by the names given to those entities in certain existing 3GPP specifications, but it may be understood that in the future those entities and functionalities may be identified by other names and certain entities or functions may be combined in future specifications published by 3GPP, including future 3GPP NR specifications. Thus, the particular network entities and functionalities described and illustrated in FIGS. 8A, 8B, 8C, 8D, and 8E are provided by way of example only, and it may be understood that the subject matter disclosed and claimed herein may be embodied or implemented in any similar communication system, whether presently defined or defined in the future.

FIG. 32E illustrates an example communications system 111 in which the systems, methods, apparatuses described herein may be used. Communications system 111 may include Wireless Transmit/Receive Units (WTRUs) A, B, C, D, E, F, abase station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C. D. E, and F may be out of range of the access network coverage 131. WTRUs A, B, and C form a V2X group, among which WTRU A may be the group lead and WTRUs B and C are group members.

WTRUs A, B, C, D, E, and F may communicate with each other over a Uu interface 129 via the gNB 121 if they are within the access network coverage 131. In the example of FIG. 32E. WTRUs B and F are shown within access network coverage 131. WTRUs A, B, C, D, E, and F may communicate with each other directly via a Sidelink interface (e.g., PC5 or NR PC5) such as interface 1232A, 1232B, or 128, whether they are under the access network coverage 131 or out of the access network coverage 131. For instance, in the example of FIG. 32E, WRTU D, which may be outside of the access network coverage 131, communicates with WTRU F, which may be inside the coverage 131.

WTRUs A, B, C, D, E, and F may communicate with RSU 123a or 123b via a Vehicle-to-Network (V2N) 133 or Sidelink interface 1232B. WTRUs A, B. C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 32F may be a block diagram of an example apparatus or device WTRU 102 that may be configured for wireless communications and operations in accordance with the systems, methods, and apparatuses described herein, such as a WTRU 102 of FIG. 32A, 8B, 8C, 8D, or 8E. As shown in FIG. 32F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 32F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 32F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 32A) over the air interface 115/116/117 or another UE over the air interface 1132D/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 may be depicted in FIG. 32F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that may not be physically located on the WTRU 102, such as on a server that may be hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., fingerprint) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 32G may be a block diagram of an exemplary computing system 90 in which one or more apparatuses of the communications networks illustrated in FIGS. 8A, 8C, 8D and 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software may be stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 may be an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 may be the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which may be controlled by display controller 96, may be used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that may be sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A, 8B, 8C, 8D, and 8E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It may be understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1-16. (canceled)

17. A wireless transmit/receive unit (WTRU), comprising a transceiver and one or more processors, configured to:
receive a Medium Access Control (MAC) Control Element (CE), wherein the MAC CE indicates an activation of a plurality of Transmission Configuration Indicator (TCI) states for a TCI codepoint;
receive a first Physical Downlink Control Channel (PDCCH) transmission comprising the TCI codepoint;
receive a second PDCCH transmission using first TCI states of the plurality of activated TCI states, wherein the second PDCCH transmission includes information for scheduling a Physical Uplink Control Channel (PUCCH) transmission or a Physical Uplink Shared Channel (PUSCH) transmission with multiple transmission occasions; and
transmit, by using second TCI states of the plurality of activated TCI states, the PUCCH transmission or the PUSCH transmission on the multiple transmission occasions, wherein different TCI states of the second TCI states are used in different transmission occasions of the multiple transmission occasions.

18. The WTRU of claim 17, wherein the first TCI states comprise a plurality of downlink (DL) TCI states and the second TCI states comprise a plurality of uplink (UL) TCI states.

19. The WTRU of claim 17, wherein a TCI state of the plurality of TCI states is used at an activation time and the first PDCCH transmission is received prior to the activation time.

20. The WTRU of claim 17, wherein the plurality of TCI states for the TCI codepoint are associated with a control resource set (CORESET) pool index value and the first PDCCH transmission is received on a CORESET associated with the CORESET pool index value.

21. The WTRU of claim 17, wherein the MAC CE comprises a TCI state identification field for the TCI codepoint.

22. The WTRU of claim 17, wherein the MAC CE comprises a number of Transmission Configuration Indicator (TCI) state identifiers for activation.

23. The WTRU of claim 17, wherein the PDCCH transmission comprises Downlink Control Information (DCI) and the DCI comprises an indication of the TCI codepoint.

24. The WTRU of claim 17, wherein the activated TCI states are activated based on a TCI activation timeline.

25. The WTRU of claim 17, wherein the first PDCCH transmission is received before one or more of the plurality of TCI states are activated.

26. A method performed by a wireless transmit/receive unit (WTRU), the method comprising:
receiving a Medium Access Control (MAC) Control Element (CE), wherein the MAC CE indicates an activation of a plurality of Transmission Configuration Indicator (TCI) states for a TCI codepoint;
receiving a first Physical Downlink Control Channel (PDCCH) transmission comprising the TCI codepoint;
receiving a second PDCCH transmission using first TCI states of the plurality of activated TCI states, wherein the second PDCCH transmission includes information for scheduling a Physical Uplink Control Channel (PUCCH) transmission or a Physical Uplink Shared Channel (PUSCH) transmission with multiple transmission occasions; and
transmitting, by using second TCI states of the plurality of activated TCI states, the PUCCH transmission or the PUSCH transmission on the multiple transmission occasions, wherein different TCI states of the second TCI states are used in different transmission occasions of the multiple transmission occasions.

27. The method of claim 26, wherein the first TCI states comprise a plurality of downlink (DL) TCI states and the second TCI states comprise a plurality of uplink (UL) TCI states.

28. The method of claim 26, wherein a TCI state of the plurality of TCI states is used at an activation time and the first PDCCH transmission is received prior to the activation time.

29. The method of claim 26, wherein the plurality of TCI states for the TCI codepoint are associated with a control resource set (CORESET) pool index value and the first PDCCH transmission is received on a CORESET associated with the CORESET pool index value.

30. The method of claim 26, wherein the MAC CE comprises a TCI state identification field for the TCI codepoint.

31. The method of claim 26, wherein the MAC CE comprises a number of Transmission Configuration Indicator (TCI) state identifiers for activation.

32. The method of claim 26, wherein the PDCCH transmission comprises Downlink Control Information (DCI) and the DCI comprises an indication of the TCI codepoint.

33. The method of claim 26, wherein the activated TCI states are activated based on a TCI activation timeline.

34. The method of claim 26, wherein the first PDCCH transmission is received before one or more of the plurality of TCI states are activated.

35. A system comprising:
one or more processors; and
memory coupled with the one or more processors, the memory storing executable instructions that when executed by the one or more processors cause the one or more processors to effectuate operations comprising:
receiving a Medium Access Control (MAC) Control Element (CE), wherein the MAC CE indicates an activation of a plurality of Transmission Configuration Indicator (TCI) states for a TCI codepoint;
receiving a first Physical Downlink Control Channel (PDCCH) transmission comprising the TCI codepoint;
receiving a second PDCCH transmission using first TCI states of the plurality of activated TCI states, wherein the second PDCCH transmission includes information for scheduling a Physical Uplink Control Channel (PUCCH) transmission or a Physical Uplink Shared Channel (PUSCH) transmission with multiple transmission occasions; and
transmitting, by using second TCI states of the plurality of activated TCI states, the PUCCH transmission or the PUSCH transmission on the multiple transmission occasions, wherein different TCI states of the second TCI states are used in different transmission occasions of the multiple transmission occasions.

36. The system of claim 35, wherein the first TCI states comprise a plurality of downlink (DL) TCI states and the second TCI states comprise a plurality of uplink (UL) TCI states.
